(19) United States
(12) Patent Application Publication
(10) Pub. No.: US 2001/0027455 A1
(43) Pub. Date: Oct. 4, 2001

(54) Strategic planning system and method

(76) Inventors: Aly Abulleil, Pittsburgh, PA (US); William H. Seipp, Wexford, PA (US)

Correspondence Address: Dennis M. Carleton, Buchanan Ingersoll, One Oxford Centre, 20th Floor, Pittsburgh, PA, 15219, US

(21) Appl. No.: 09/829,891

(22) Filed: Apr. 10, 2001

Related U.S. Application Data
(63) Continuation of application No. 09/137,959, filed on Aug. 21, 1998.

(51) Int. Cl. G06F 17/60

(52) U.S. Cl. 707/102; 705/10

(57) ABSTRACT

A computer-implemented method for planning. The method includes assessing market attractiveness and competitiveness of an idea and planning to implement the idea. Planning to implement the idea includes predicting results based on implementation of the idea, creating a plan, and automatically re-predicting results of implementing the plan. The method also includes outputting the plan.

### CROSS-REFERENCE TO RELATED APPLICATIONS

This application is related to patent application Ser. No. 09/137,959, filed on Aug. 21, 1998.

### BACKGROUND OF THE INVENTION

1. Field of the Invention

The present invention is directed generally to a method and system to assist in making decisions and, more particularly, to a method and system for strategic planning.

2. Description of the Background

Formal planning processes provide a framework for determining what should be done in order to achieve a goal in the future. These processes typically focus on empirical validation using traditional planning tools such as simulation, probability theory, linear programming, and cost/benefit analyses. These processes typically neglect the “human side” of planning by ignoring the relative value inherent in different strategies and choices, and conflict among those choices. The processes generally have no way to manage the effects of management priorities and they do not consider intangible elements that cannot be measured or calculated within statistical margins of error. Also, the processes are not dynamic, but instead rely on static documents whose value expires almost as soon as the planning process is completed.

It has been known since the 1970's that a process called the Analytic Hierarchy Process (AHP) can be used to perform decision analysis using a mathematically valid method of integrating quantitative and qualitative priorities in a formal decision-making process. AHP allows for a decision to be made based on human behavioral thought processes and allows the decision-maker to maintain cohesive thought patterns while expediting the natural decision-making process.

AHP has, at its core, three basic principles. First, hierarchies are structured for each component of a complex problem to form a “complete picture” of the problem. Second, priorities are established in order of importance and with the relative intensities of importance for each priority. Finally, the logical consistency of the priorities in relation to the hierarchies is examined to ensure that the problem has been modeled with coherent relationships and priorities that are mathematically consistent. A discussion of AHP can be found in Saaty, T., “Decision Making for Leaders,” 1990, which is incorporated herein by reference. This reference describes in detail matrix mathematics and eigenvector calculations used to compute local and global weights or priorities based upon pairwise comparison of criteria of alternatives.

The user of an AHP process starts with a goal element. The goal element represents a whole unit and thus the local and global weights of the goal element equal one. Criteria elements are identified with respect to the goal and sub-criteria elements can be identified with respect to each of the criteria or sub-criteria. The group of criteria elements with respect to the goal or any group of sub-criteria elements relative to the next higher level criteria or sub-criteria is called a plex. The AHP method uses eigenvector mathematics to calculate local weights of the criteria within each plex based upon pairwise comparison of each element in the plex with every other element in that plex. One characteristic of the weights in a hierarchy is that the local weights of the elements in each plex always add to one. The global weights of each element in the hierarchy are computed by multiplying the local weight of the element by the global weight of its parent element in the hierarchy. Another characteristic of weights in a hierarchy is that the criteria elements in the plex whose parent is the goal will have global weights that equal the local weights. Yet another characteristic is that the sum of all global weights of all leaf elements in the hierarchy, i.e. all hierarchy elements that have no sub-elements (children) add to one. Thus, the hierarchy consists of weighted criteria and sub-criteria elements where all criteria elements have weights that are ratios to each other. A synthesis calculation computes a prioritized graph of all the leaf element criteria. The sum of all the weights of a synthesis calculation equals one.

In the AHP process, the weights of alternatives of the decision-making process can be computed either as weighted sub-elements relative to each the lowest level sub-criteria or they can be rated against the lowest sub-element criteria in a ratings sheet. In the ratings sheet method, the user must create a ratings scale that is appropriate for determining how well an alternative in the ratings sheet meets each lowest level criteria element. Thus, any alternative in a ratings sheet that fully meets all of the lowest level criteria will have a ratings result equal to one. Furthermore, any alternative in a ratings sheet that has a ratings result of 0.5 can truly be referenced as having half the priority of another alternative that has a ratings result of 1.0 because all calculations are based on ratios.

Prior computer-implemented versions of AHP have been developed. For example, the AliahTHINK!™ version 2.5 software package, sold by the assignee of the instant invention, implemented AHP, but did not allow for seamless interaction between a module used for planning a course of action and a module used for predicting the outcome of a desired course of action. The AliahTHINK!™ version 2.5 software package also has the disadvantage that it does not allow for the use of previously gathered information from a database. The AliahTHINK!™ version 2.5 software package also has the disadvantage that it does not allow for an integrated view of planning modules within the context of a business development process of stages and gates. Furthermore, the AliahTHINK!™ version 2.5 software package has the disadvantage that it does not allow for an automated assistant to guide a user or team of users through the decision analysis process. Also, the AliahTHINK!™ version 2.5 software package has the disadvantage that it does not provide for an automated publishing of decision analysis results on the user's Internet or intranet sites.

Thus, there is a need for a computer-implemented system and method based on AHP principles that allows for seamless interaction between a planning module and a prediction module. There is also a need for a computer-implemented system and method based on AHP principles that allows for the use of previously gathered information from a database. There is also a need for a computer-implemented system and method based on AHP principles that allows for an integrated access to planning modules within the context of a business development process of stages and gates. Furthermore, there is a need for an automated assistant tool to guide the user or team of users through the decision analysis process. Also, there is a need to provide an integrated tool for automated publishing of decision analysis results on a user's Internet or intranet sites.

### SUMMARY OF THE INVENTION

The present invention is directed to a computer implemented method for planning. The method includes assessing market attractiveness and competitiveness of an idea, and planning to implement the idea. Planning to implement the idea includes predicting results based on implementation of the idea, creating a plan, and automatically re-predicting results of implementing the plan. The method also includes outputting the plan.

The present invention represents a substantial advance over prior systems and methods for strategic planning. The present invention has the advantage of allowing for seamless interaction between the planning and predicting functions inherent in strategic planning methods and systems. The present invention also has the advantage that it allows for the incorporation of previously gathered information from a database. Furthermore, the present invention has the advantage of providing an integrated view of planning modules within the context of a business development process of stages and gates. Furthermore, present invention has the advantage of outputting the plan in report format and in web page format. Also, the present invention provides for an integrated automated assistant tool to guide users through the planning process.

### BRIEF DESCRIPTION OF THE DRAWINGS

For the present invention to be clearly understood and readily practiced, the present invention will be described in conjunction with the following figures, wherein:

FIG. 1 is a diagram illustrating a strategic planning system;

FIG. 2 is a diagram illustrating a typical process flow through the system illustrated in FIG. 1;

FIG. 3 is a diagram illustrating the flow through the hierarchy engine illustrated in FIG. 1;

FIGS. 4-5 are diagrams illustrating the flow through the portfolio module illustrated in FIG. 1;

FIG. 6 is a diagram illustrating the flow through the listen module of FIG. 1;

FIGS. 6A-6C are graphs illustrating priorities of three buying criteria;

FIG. 7 is a diagram illustrating the flow through the best-in-class module of FIG. 1;

FIG. 8 is a diagram illustrating the flow through the predict/plan module of FIG. 1;

FIG. 9 is a diagram illustrating the flow through the predict module of FIG. 8;

FIG. 10 is a diagram illustrating the flow through the plan module of FIG. 8;

FIG. 11 is a diagram illustrating the flow through the allocate module of FIG. 1; and

FIGS. 12-56 are screen printouts illustrating an example of the operation of an embodiment of the system of FIG. 1.

### DETAILED DESCRIPTION OF THE INVENTION

The system and method of the present invention are described herein as being applied to the planning, or decision-making process, of an organization. This description is exemplary, and any type of entity or individual may use the teachings of the present invention to facilitate the planning or decision-making process. Also, as used herein, the term “user” can include, for example, a consultant, an individual using the system and method of the present invention, or a representative or representatives of an organization using the teachings of the present invention to aid in the decision-making process. The term “user” can refer to an individual or it may refer to a group of individuals working together in a team.

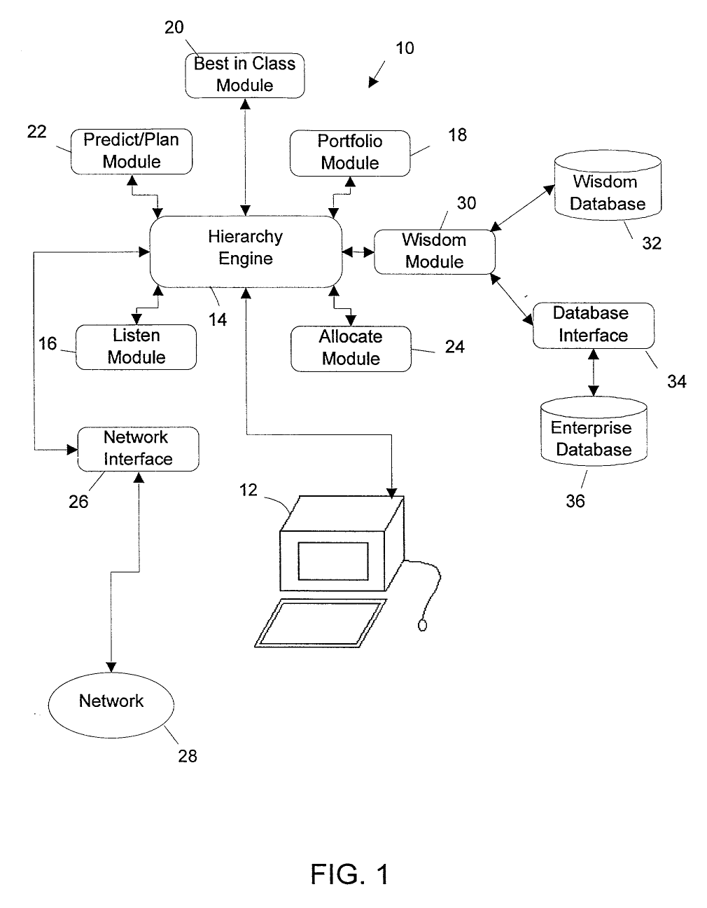

FIG. 1 is a diagram illustrating a strategic planning system 10. The system 10 includes a computer 12, which executes the various modules comprising the software portion of the system 10. The computer 12 may be any type of computing system suitable to execute the modules such as, for example, an IBM compatible PC, an Apple Macintosh, a workstation, a personal decision aid (PDA), or an application specific integrated circuit (ASIC).

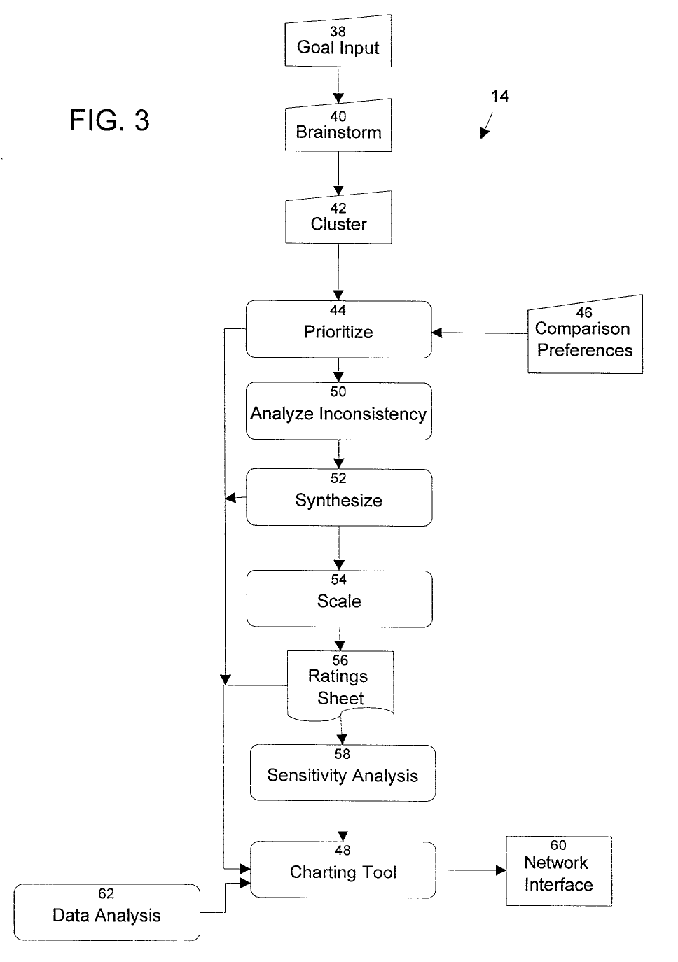

The system 10 includes a hierarchy engine 14. The hierarchy engine 14 implements the functions required to perform AHP decision-making, as described hereinafter in conjunction with FIG. 3. The modules that interact with the hierarchy engine 14 do so as “templates”, or objects, and implement various functions that utilize the AHP functionality of the hierarchy engine 14. The modules and the hierarchy engine 14 may be created in any computer language suitable such as, for example, C or C++ using, for example, conventional or object-oriented techniques.

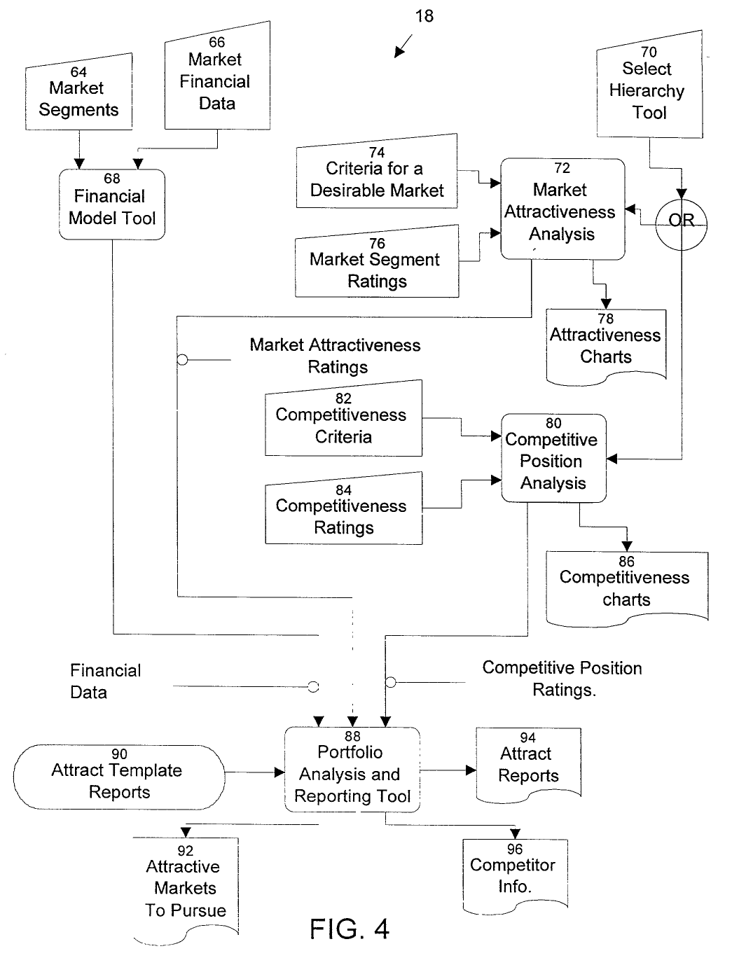

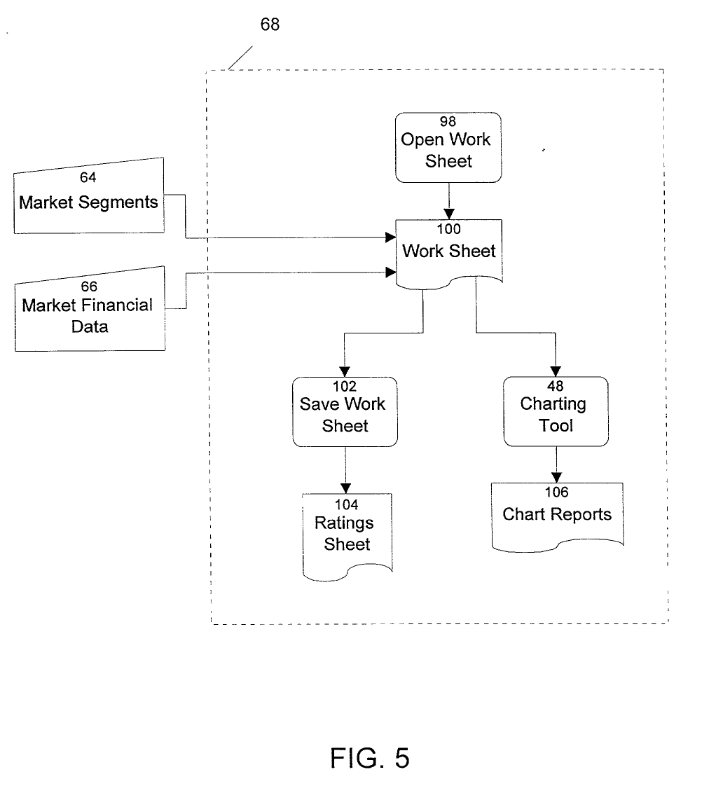

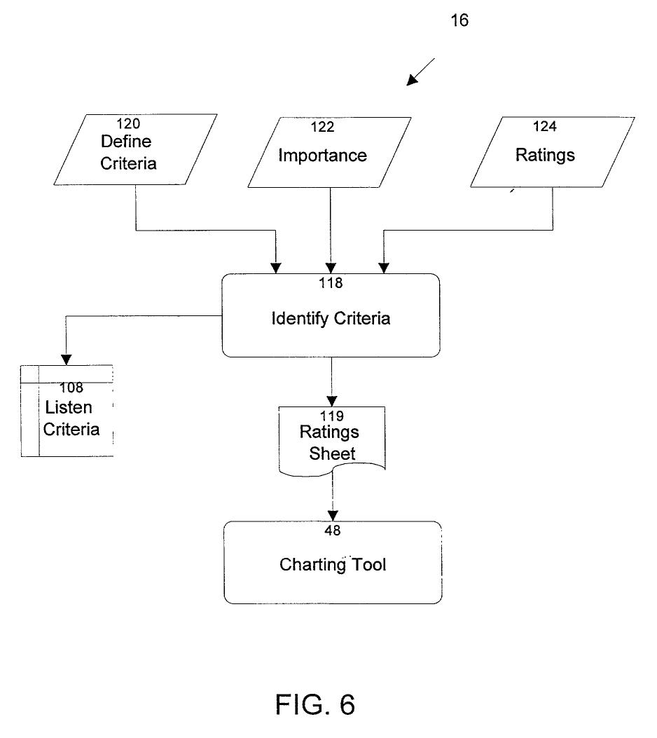

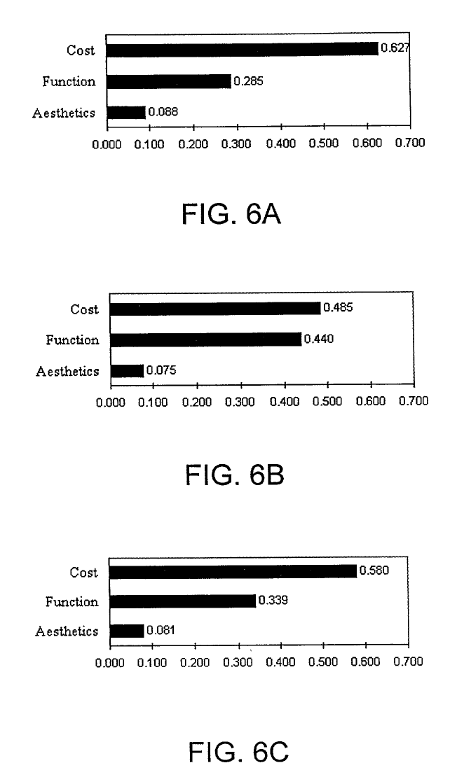

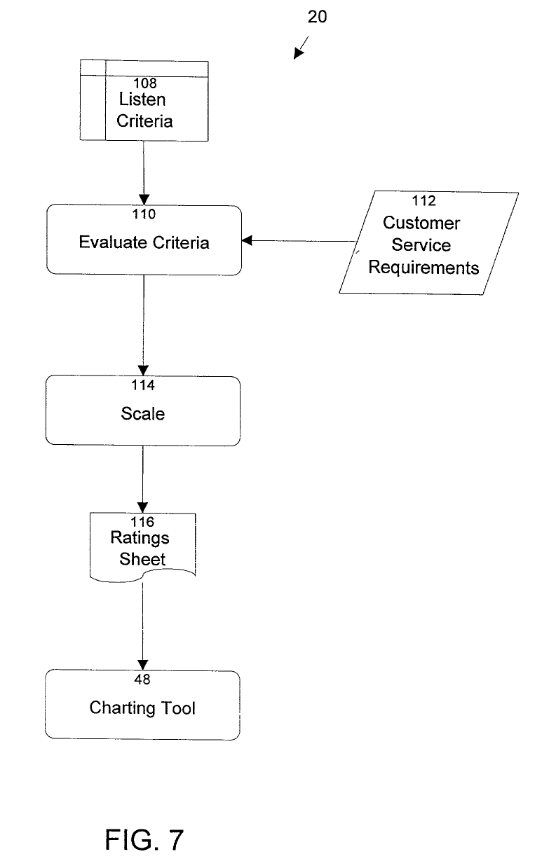

A listen module 16 uses the AHP principles of the hierarchy engine 14 to allow the entry and analysis of the judgments of a number of people using, for example, focus groups or surveys, as described hereinafter in conjunction with FIG. 6. A portfolio module 18 uses the AHP principles of the hierarchy engine 14 to assess market attractiveness and competitiveness of an idea such as, for example, a product or service that may or may not exist, as described hereinafter in conjunction with FIGS. 4-5. A best-in-class module 20 uses the AHP principles of the hierarchy engine 14 to assess how well an organization is serving the needs of, for example, its customers, relative to best in class competition as described hereinafter in conjunction with FIG. 7.

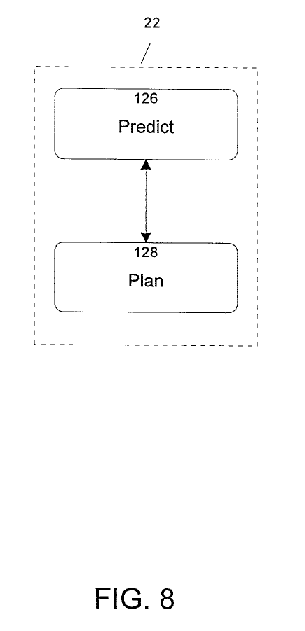

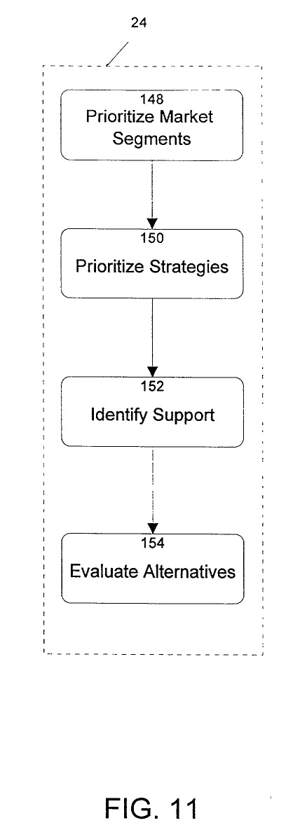

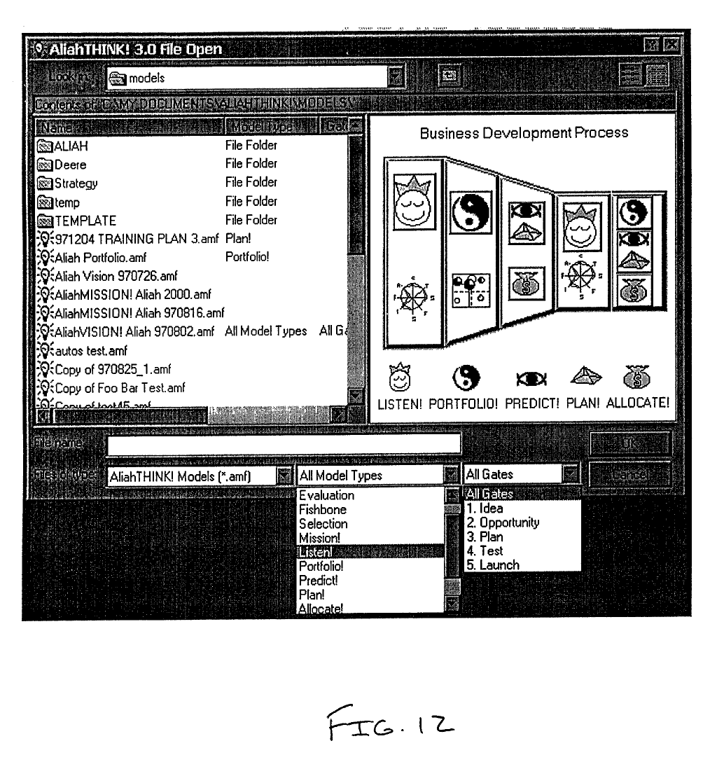

A predict/plan module 22 uses the AHP principles of the hierarchy engine 14 to determine the most important forces affecting the organization in the marketplace in which it wants to participate and to identify and prioritize strategic actions to implement initiatives that address the organization's challenges, as described hereinafter in conjunction with FIGS. 8-10. An allocate module 24 uses the AHP principles of the hierarchy engine 14 to tie the resource allocation decisions of the organization to its strategies, as described hereinafter in conjunction with FIG. 11.

The hierarchy engine 14 is in communication with a network interface 26, which establishes a communication link to a network 28 such as, for example the Internet and/or an intranet. The interface 26 can be, for example, a web server that is connected to a local area network or directly to the Internet 28.

A wisdom module 30 is in communication with the hierarchy engine 14 to provide the hierarchy engine 14 with information, “knowledge” and priorities (i.e. wisdom) that is important to the organization. The wisdom module 30 is in communication with a wisdom database 32. The wisdom database 32 contains wisdom that was obtained during previous usage of the system 10 by the organization. The wisdom can relate to, for example, structures of criteria, priorities and rated alternatives for individual market players such as customers and competitors, or structures that aggregate priorities for a player class in a whole market segment. The wisdom module 30 is also in communication with a database interface 34.

The database interface 34 acts as an interface between the hierarchy engine and an enterprise database 36. The enterprise database 36 contains information that is gathered by an organization independent of the execution of the system 10. The information stored in the database 36 can relate to, for example, data and knowledge such as sales, trends and financial data as well as business rules that are important in determining priorities in the planning process. The database interface 34 can be implemented by using database specific interfaces such as, for example, an interface to the SAP enterprise applications. In many cases the database interface 34 can be implemented through the industry standard ODBC interface that is supported by many database vendors such as, for example, Oracle and Microsoft. The database interface 34 is useful wherever information retrieval and storage makes sense in a decision-making process. Data may determine the relative importance of criteria such as, for example, criteria based on cost information. Other data may be needed in the work sheet so that business information such as financial data used in the decision-making process is up to date.

Production scheduling is an example of a planning problem for which hierarchical decision-making can provide a benefit through a database interface. In this application, for example, production constraints are identified in a database used by production scheduling software such as, for example, the Optiflex software from I2 Corporation. A database log-on screen of the usual variety is provided to allow the user to enter a user name and password needed for connecting to the user's database. Production constraints are input into the present invention as leaf elements in a hierarchical structure through an ODBC interface that uses a select statement to retrieve the relevant information. The user determines the hierarchical structure that includes relevant criteria and priorities to prioritize the relative impact or severity of the constraints on the user's production system. The resulting weighted synthesis of the constraints is fed back to the scheduling software's database through a programmed loop of OCBC update statements that store new constraint values for the scheduling system to use. Alternatively, production constraints can be rated in a ratings sheet where the ratings result values represent the production constraint priorities. In this case, the normalized ratings result values are sent back to the production scheduling system's database as the constraint priority values. This system allows the user to create production constraint scenarios in hierarchical format where the priorities represent current customer priorities, current market conditions and current business priorities.

The present invention can be implemented on an ODBC database so that all the information discussed herein as relating to the present invention is stored in a relational database. Various tables can be set up to save hierarchy element names and definitions, the hierarchical links between elements, pairwise comparison voting sessions, survey responses, reports, HTML pages, charts, work sheets, rating sheets, process assistant steps, etc. The relational structures of the present invention can be stored in a Sybase SQL database format through an ODBC interface, making it possible that they can also be included for example in the corporate database of the user.

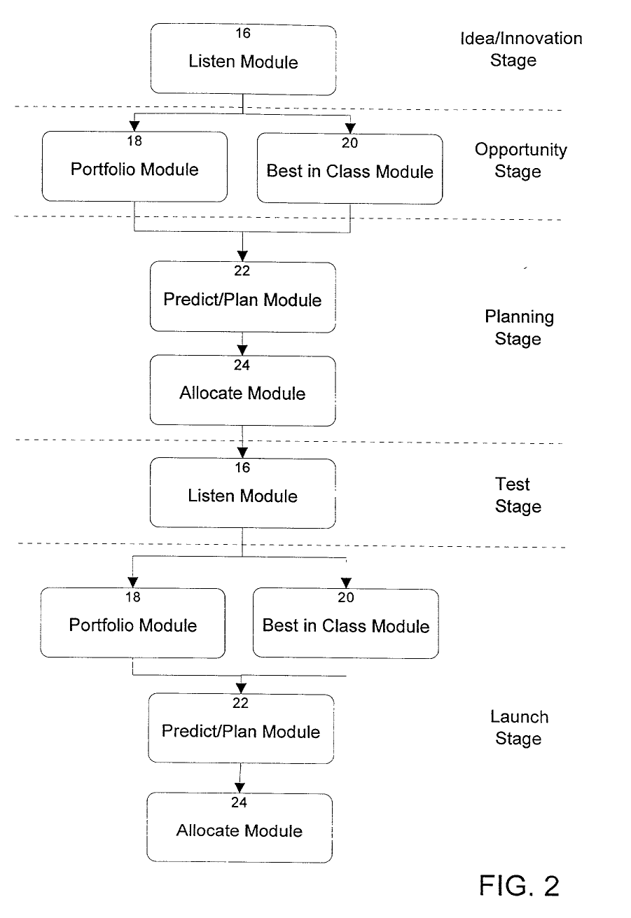

FIG. 2 is a diagram that illustrates a typical process flow through the system 10 illustrated in FIG. 1. The flow is configured for strategic planning decisions to be made by an organization using a business development process. The flow illustrated in FIG. 2 is exemplary of the order of execution of the modules of the system 10. Although the flow of FIG. 2 is typical, the modules of the system 10 can be executed in any order that is logical given the needs of an organization or a user and the nature of the decision(s) which is being made with the aid of the system 10. Also, although the flow through the system 10 as described in FIG. 2 is for a business development process, the system 10 can be used to make decisions in any area using AHP principles.

The flow through the system 10 starts with the execution of the listen module 16 during an idea/innovation stage. The listen module 16 is used to assess the needs of the marketplace, to determine whether a proposed opportunity addresses a need and whether the organization's proposed product can address the need better than existing options, including options from the competition. The listen module 16 allows for the incorporation of customer values, feelings, and perceptions while including both qualitative and quantitative variables in a mathematically valid manner through the use of AHP. Many alternatives are rejected at the idea/innovation stage.

The flow through the system 10 then moves to the parallel execution of the portfolio module 18 and the best-in-class module 20 during an opportunity stage. Alternatives are evaluated at the opportunity stage which meet a need in the marketplace as determined by the decision-making process in the idea/innovation stage. The portfolio module 18 is used to evaluate whether a proposed product, project, acquisition, etc. meets the organization's business objectives by performing market attractiveness and competitive position analyses. The best-in-class module 20 is an example of an optional module that can be custom developed by the user and added to the organization's business development process. An organization may wish to extend its business development process with other modules developed at other stages in the business development process. Such modules would use the AHP principles of the hierarchy engine 14. The best-in-class module 20 is used to assess how well the organization is serving the needs of its customers relative to a defined list of competitors. Many alternatives are rejected at the opportunity stage.

The flow through the system 10 then moves to the execution of the predict/plan module 22 during a planning stage. Alternatives evaluated at the planning stage are alternatives that meet a need in the marketplace and, upon initial review, meet the organization's business objectives. The predict/plan module 22 is first used to analyze each market segment independently to understand the organization's future in the specific segment relative to other players that will impact the market. The predict/plan module 22 performs this analysis by surveying the market playing field and identifying the areas of greatest impact on the organization's success in the marketplace. The predict/plan module 22 is then used to define a desirable future in the marketplace and then identify the strategic actions that must be taken in order to change the balance of power in the marketplace in favor of the organization. Also, the actions are evaluated in terms of their cost to the organization and probability of success.

The allocate module 24 is also executed during the planning stage. The allocate module 24 is used to evaluate various projects associated with entering marketplaces to determine how well the projects meet the organization's objectives across markets. Some alternatives may be deemed too expensive or too narrowly focused and may be rejected at the planning stage. The allocate module develops a gain/pain/risk index by which alternatives are evaluated and either accepted or rejected.

The flow through the system 10 then moves to the execution of the listen module 16 during a test stage. Product ideas that make it to the test stage are alternatives that the organization determined meet both market needs and business objectives. The listen module 16 is used at this stage to survey customers to obtain a better understanding of customer needs, expanding market testing efforts to ensure that the marketplace is understood in all of its details. The survey feature of the listen module 16 is also used to determine whether customer needs and preferences differ according to demographics and to validate that the organization's plans have effectively addressed customer needs. Effective market segmentation can yield a significant competitive advantage.

The flow through the system 10 then moves to the parallel execution of the portfolio module 18 and an optional best-in-class module 20 at a launch stage. Alternatives that make it to the launch stage are alternatives that the organization determined meet both market needs and business objectives. The portfolio module 18 is used to clarify the business objectives of the organization relative to the opportunity being pursued. The best-in-class module 20 is used to assess how well the organization is competing to serve the needs of its customers.

The predict/plan module 22 is then executed again at a launch stage. The predict/plan module 22 first revisits the assumptions made during the execution of the predict/plan module at the planning stage. The predict/plan module 22 is also used to adjust the organization's definition of a desirable future and to ensure that the right actions were identified during the execution of the predict/plan module 22 at the planning stage. New actions are identified and evaluated in light of the most current knowledge of market conditions and priorities.

The flow through the system 10 then moves to the execution of the allocate module 24. At the launch stage, the allocate module 24 ensures that the cost analysis performed during the execution of the allocate module 24 at the planning stage was accurate and that the various projects selected for launch meet current business objectives.

FIG. 3 is a diagram illustrating the flow through the hierarchy engine 14 illustrated in FIG. 1. The flow starts with the definition of a goal at step 38. The goal defines the end result of the decision to be made. A brainstorm list is then developed at step 40. The brainstorm list is a list of ideas that relate to the achievement of the goal defined at step 38. At step 42, the elements from the brainstorm list created at step 40 are clustered into “buckets”. Each bucket is a graphical representation of a depository of elements from the brainstorm list. Each bucket has a label that categorizes the elements in the bucket according to the label.

At step 44, the elements in each bucket are prioritized using a pairwise comparison method. In the comparison method, comparison preferences 46, or judgments, are entered by the user as to the order and intensity of each element as compared to each other element in a bucket. Local weights and global weights are calculated using, for example, matrix mathematics to calculate an eigenvector of priorities and inconsistency ratio. The eigenvector calculation is described in “Decision Making for Leaders.” The weights are output to a charting tool 48 where the user can view, for example, Pareto charts and priority graphs. The charting tool 48 can be implemented, for example, by customized routines that use computer language application programming interface (API) calls to create charts and graphs. Alternatively, the charting tool 48 can use, for example, charting control software components based on the software standards of COM (component object model) and OLE (object linking and embedding). Based on the display of the weights, the user may decide to remove any elements with weights that are not significant with respect to other local weights within the decision model.

At step 50, an inconsistency analysis is performed. Inconsistency is examined both in terms of inconsistency in ordering and inconsistency in intensity. The analysis generates an inconsistency ratio by comparing the randomness of the user judgments to an index as described in “Decision Making for Leaders.” Inconsistency ratios of approximately less than or equal to 10% are generally acceptable. The user may decide to live with inconsistency ratios of higher values, especially if a group or team of individuals made the comparisons, provided that the group agrees with the priorities as viewed on a priority graph.

At step 52, a synthesis is performed to order the elements according to their relative importance. The synthesis is accomplished by performing the AHP calculations to ensure that all local and global weights are up to date. Then, the global weights of all enabled leaf elements in the hierarchy add to 1.0. The user may select to enter the charting tool 48 to display, for example, a synthesis graph that shows the elements in order of importance. A synthesis graph is a vertically oriented Pareto chart of the global weights of the enabled leaf elements of the hierarchy.

At step 54, scales are developed to score alternatives according to how well they meet each of the desired criteria relative to the goal that was defined at step 38. The desired criteria are the enabled leaf elements of the hierarchy. Each scale is developed using a scale-maker tool. A scale is a set of criteria by which an alternative is measured against a criteria hierarchy element. For example, a scale called “fit” to rate how well a program meets a selected criterion might consist of the scale levels “not applicable”, “very low”, “low”, “average”, “high”, “very high”, and “excellent”. Each scale level is weighted, for example by the AHP pairwise comparison method. The weights are adjusted by the multiplier 1/W_{Imax} so that the scale level with the most weight, presumably “excellent”, has a value of 1. Thus, if a program is rated with the scale level “excellent,” the program will receive a full credit of the global weight of the associated leaf element criterion.

Next, a ratings sheet 56 is created. The ratings sheet 56 is a spreadsheet that evaluates alternatives on the basis of how well they meet the leaf element criteria. Each leaf element has a corresponding scale against which ratings are determined. Assume by way of example that a program is being rated against a set of criteria. Assume further that each criterion has the scale “fit” attached to it. Thus, if the program is rated “excellent” against all of the leaf element criteria, the ratings sum or ratings result value will be 1.0 because all of the leaf element global weights sum to the value 1.0.

At step 56, a sensitivity analysis is performed to determine the impact of changes in criteria weights. One form of sensitivity analysis shows the impact of changing the local weights at the top of the hierarchy on the global weights at the bottom of the hierarchy. Another form of sensitivity analysis allows the user to assess the impact of adjusting the synthesis of global weights on the ratings result values of alternatives in the ratings sheet. The weights associated with each element can be changed and the ratings sheet 56 can be regenerated for the adjusted weights. The results of the sensitivity analysis can be input to the charting tool 48 to display graphically, for example, how each item scored on the ratings sheet. Such graphical displays can be, for example, an opportunity chart that shows weighted opportunity for improvement or a spider chart that shows the relative strengths of rated items. The graphical displays generated by the charting tool 48 are available to a network, such as the Internet, through a network interface 60. A data analysis step 62 can provide special insight by integrating, for example, financial data with ratings and priority charts in the charting tool 48. Data analysis can be performed, for example, using a fully integrated spreadsheet tool or can be performed using other software data analysis tools such as, for example, Microsoft Excel, which is a product of the Microsoft Corporation.

FIGS. 4-5 are diagrams illustrating the flow through the portfolio module 18 illustrated in FIG. 1. The portfolio module 18 allows a planning team to assess the value of an organization's current and potential markets by determining the characteristics that make markets attractive and the characteristics to be used to evaluate the competitive position of the organization in each market. The portfolio module uses General Electric's Multi-Factor Portfolio Matrix. Alternatively, other portfolio models may be used such as for example, the Boston Consulting Group (BCG) grid or the Shell/Directional Policy Matrix (Shell/DPM). These three models are described in Segev, E., “Corporate Strategy Portfolio Models,” 1995 which is incorporated herein by reference. In FIG. 4, market segment names 64 and market financial data 66 for each market segment are input to a financial model tool 68 which is implemented as rows and columns of data in an internal spreadsheet. The financial data 66 can include, for example, information relating to market size, growth rate, and market share. The financial model tool 68 uses user-defined formulas and data structures entered into an integrated spreadsheet component to represent the financial data that the user desires to integrate in the portfolio analysis. Such user-defined formulas and data structures generally provide for the inclusion of market size, market growth rate and percentage market share data. The user can import spreadsheets and data tables from other software packages including, for example, Microsoft Excel.

At step 70, the user selects the choice of performing a market attractiveness analysis or a competitive position analysis. If the user selects the market attractiveness analysis option, the flow moves to step 72. Criteria for a desirable market 74 and market segment ratings 76 are input to the market attractiveness analysis step 72. The criteria 74 can include, for example, market size and market growth rate. The portfolio module 18 provides, for example, 8 initial criteria that make a market attractive. Users are asked to define each criterion in terms of the organization's business needs. The eight initial criteria can be, for example, market size, growth rate, profitability, technology fit, strategic fit, competition, suppliers and externalities. Users can break these criteria down into sub-criteria and sub-sub-criteria as needed. The ratings 76 can include, for example, how well selected market segments meet the attractiveness criteria 74. At the market attractiveness analysis step 72, given markets are evaluated relative to the criteria 74. The criteria 74 are prioritized according to their relative importance, thus enabling the user to focus on the characteristics that make up, for example, 80% of what is important to the organization. The market attractiveness analysis step 72 produces attractiveness charts 78, which denote the overall attractiveness of the markets to the organization based upon the weighted criteria for a desirable market 74 and the market segment ratings 76.

If the user selects the competitive position analysis option at step 70, the flow moves to step 80. Competitiveness criteria 82 and competitiveness ratings 84 are input to the competitive position analysis step 80. The criteria 82 can include, for example, the organization's market share and the organization's growth rate. The portfolio module 18 provides, for example, 8 initial criteria that make an organization competitive. Users are asked to define each criterion in terms of the organization's business needs. The eight initial criteria are, for example, market share, organization growth rate, organization profitability, organization technology fit, organization strategic fit, organization competition, organization suppliers and organization externalities. Users can break these criteria down into sub-criteria and sub-sub-criteria as needed. The ratings 84 can include, for example, how well selected market segments meet the competitiveness criteria 82. At the competitive position analysis step 80, the organization defines and prioritizes the competitiveness criteria 82 as a way to beat the competition. The organization reviews its current or potential competitiveness in each of the markets by evaluating its competitiveness with respect to each of the criterion 82. The competitive position analysis step 80 produces competitiveness charts 86, which denote the organization's competitiveness in the markets.

A portfolio analysis and reporting tool 88 analyzes and reports the results of the financial model tool 68, the market attractiveness analysis step 72, and the competitive position analysis step 80. Attract template reports 90, which contain descriptions of the analysis including, for example, priorities and a prioritized bubble position chart, are input to the portfolio analysis and reporting tool 88. The bubble position chart is further described in the GE Analysis literature referenced above. The portfolio analysis and reporting tool 88 outputs a prioritized list of attractive markets to pursue 92, attract reports 94 which describe the analysis with priorities and charts, and a list of competitor information 96, such as, for example, ratings of competitors that the user considers to be best of breed, and ratings of the user's own organization. The purpose is to report a perspective on the organization's competitiveness relative to best of breed competition.

FIG. 5 is a diagram illustrating a flow through the financial model tool 68 of FIG. 4. The flow starts at step 98, where a worksheet 100 is open. The market segments 64 and the market financial data 66 are input to the worksheet 100. Although a template of information is provided, the user is free to enter equations and data that are important to the particular analysis at hand. At step 102, the worksheet 100 is saved to storage and the market segments 64 are saved in a ratings sheet 104. The worksheet 100 is also input to the charting tool 48 that can be used to generate, for example, chart reports 106. Chart reports contain, for example, graphical representations of the financial data hierarchy priorities and ratings.

FIG. 6 is a diagram illustrating the flow through the listen module 16 of FIG. 1. At step 118, the listen criteria 108 are identified based on the user's input of criteria definitions 120, criteria importance 122, and ratings 124. The criteria definitions 120 can include, for example, function, cost and aesthetics. The criteria importance 122 is derived from pairwise comparisons per the AHP method. The ratings 124 can include, for example, the ratings of a specific product and the ratings of a best of breed competitor's product. Based on the criteria definition 120, the criteria importance 122, and the ratings 124, the listen criteria 108 represent the criteria that make up, for example, 80% of a customer's buying decision.

The listen criteria 108 can be, for example, eight criteria that are standard for any buying decision. The listen module 16 is initialized with, for example, eight standard criteria by which any purchase decision can be made. The eight initial criteria names are, for example, function, aesthetics, cost, technology, strategy, fears, supply and influences. The listen criteria 108 can be made specific to a particular buying decision through definitions. For example, in making a decision whether to purchase a company, the criteria “costs” may include “life cycle costs” such as, for example, electric utility rates and capital expenditures such as plant and equipment updates. Life cycle costs for the purchase of a computer may include, for example, a hard-drive upgrade in two years, etc. The definitions of the criteria should be seen through the eyes of the target customer and it is best if the user asks the customer directly.

The listen criteria 108 may be defined in terms of sub-criteria to any depth of hierarchical breakdown. Ratings scales (not shown) can be defined for each of the listen criteria 108 at the lowest level of hierarchical breakdown. A ratings sheet 119 can be created to rate how well a product or service of a best-of-breed competitor meets the needs of a customer. The charting tool 48 can be used to create, for example from the ratings sheet 119, an opportunity chart that shows prioritized areas of most opportunity to improve in the eyes of the customer, or an opportunity chart that shows the prioritized areas of opportunity available to be better than the competitor in the eyes of the customer. The charting tool 48 could also be used to create a spider chart that can be used to compare the organization's product or service to the product or service of a best-of-breed organization. A weighted spider chart can also be used to show how well the organization is doing relative to the best-of-breed competition for the most important of the listen criteria 108 in the eyes of a customer. The charts and reports generated by the charting tool 48 can be used as a catalyst for thinking and analysis in other modules.

After the listen criteria 108 are defined, a questionnaire can be generated that allows the survey or focus group participants to respond with their personal purchase decision priorities through pairwise comparison. The questionnaire can be generated electronically so that participants can enter their priorities into the computer directly, or the questionnaire can be printed and later the priorities can be entered into the computer by a computer operator. Per the AHP process and in the case where there are eight listen criteria, twenty-eight pairs of comparisons are made by each participant and each of these individual sets of comparisons are entered into the computer for analysis. Each set of participant comparisons has an associated priority graph and inconsistency ratio as well as a set of demographic data that may be useful in determining if there are statistical differences among participants based upon the demographic information.

The following is a description of the statistical calculations needed to determine whether there are statistically significant differences among demographically segmented sets of participant priorities. In the AHP process of pairwise comparison, the comparison scale used is a one-to-nine scale where 1 indicates that the two criteria are of equal importance; 3 indicates a moderate degree of importance between two criteria; 5 indicates a strong degree; 7, a very strong degree; and 9, one is extremely more important than the other. Values of 2, 4, 6 and 8 fall in between. These comparisons, designated as aᵢⱼ, make up a reciprocal matrix which is used to calculate the relative importance of the criteria for each person (i and j indicate the two criteria being compared).

In addition to the paired comparisons, the demographic data gathered for each person is used to develop potential sub-groupings of respondents for the statistical analysis. For example, one may be interested in whether buying characteristics for a given product or service differ among various age groups or by geographic location, gender or profession. Sub-groupings based on combinations of these categories may also be of interest. It is important that at least 30 to 50 valid survey responses are collected in order to obtain meaningful results.

Once the data is gathered, the statistical inference process can begin. The hypothesis of interest is:

H_{O}:μᵢⱼ^{(u)}=μᵢⱼ^{(O)}∀i,j;i<j (1)

which says that the average judgments for each sub-group, μᵢⱼ^{(u)}, are the same and given by the average judgments of all the respondents, μᵢⱼ^{(O)}. Rejecting the null hypothesis, then, states that the sub-groups are significantly different and should be treated as such.

Basak, I., “When to Combine Group Judgments and When Not To in the Analytic Hierarchy Process: A New Method”, Mathl Comput. Modelling, Vol. 10, No. 6, pp. 395-404, 1988, which is incorporated herein by reference, uses the likelihood-ratio-test for testing the above hypothesis, calculating the maximum likelihood estimates of the parameters of the likelihood function for each sub-group and for the entire data set. The ratio of these is formed to obtain the overall test statistic which follows the χ² distribution.

The listen module 16, can calculate the maximum likelihood estimates of the parameters of the likelihood functions and then takes their ratio. This test statistic is evaluated at the 90%, 95% and 99% confidence levels. If the null hypothesis is accepted (i.e. there is no significant difference among sub-groups) then the estimated priorities of the buying criteria for all respondents are calculated and reported. If the null hypothesis is rejected (i.e., the sub-groups are significantly different) the estimated priorities for each subgroup are calculated and reported.

The next step in the statistical calculation is the calculation of the maximum likelihood estimates. As mentioned above, the input to the calculations are the paired comparison judgments (aᵢⱼ;i<j) of all the respondents which form a reciprocal matrix. In other words, when a respondent judges criterion i to be “moderately more important” (3 times) than criterion j, it is assumed that the importance of criterion j is ⅓ that of criterion i. In the reciprocal matrix, the entry for criterion i vs. criterion j (aᵢⱼ) is 3 and that for criterion j vs. criterion i (aᵢⱼ) is ⅓. This assumption is normal for the AHP and simplifies the calculations of the maximum likelihood estimates.

The user must define the sub-groups of interest using the demographic data. These sub-groups can be defined by any of the individual demographic categories or any combination. It is important to note that each sub-group must have at least two respondents in order to determine variation among the group members. Let aᵢⱼ^{uk} be the paired comparison judgment of Criterion i vs. Criterion j given by the kth respondent in the uth group; k=1, 2, . . . , rᵤ, u=1, 2, . . . , g, where rᵤ is the number of judges in the uth group and g is the number of groups. Also, let t be the number of criteria. Following Basak, the program calculates the log of the judgments from the judgment matrices (bᵢⱼ=In aᵢⱼ) and creates the corresponding vectors.

Next, the average bᵢⱼ for each sub-group, \hat{μ}ᵢⱼ^{(u)}, is calculated for the off-diagonal entries from:

$${\hat{μ}}_{ij}^{( u )} = {\overline{y}}_{ij}^{( u )} = \frac{{\sum }_{k = 1}^{{r}_{a}} ln {a}_{ij}^{uk}}{{r}_{a}} \qquad ( 2 )$$

These form a vector containing the maximum likelihood estimates for the means for each group (and subsequently for all entries). Entries to a dispersion vector (\hat{Z}) for each group are then calculated from:

\hat{z}ᵢⱼ^{(u)}=bᵢⱼ^{(u)}−\hat{μ}ᵢⱼ^{(u)};i<j (3)

These are then used to calculate the maximum likelihood estimates for the eigenvalues of the dispersion matrices which are used in the calculation of the likelihood function, L(m,n,Z), for the alternative hypothesis where m and n are eigenvalues associated with the dispersion matrix, Z. The process is repeated for the entire data set to determine the value of the likelihood function for the null hypothesis. The likelihood ratio statistic, λ, is the ratio of the values for the likelihood functions of the null and alternative hypotheses, respectively. The value, −21nλ, follows the χ² distribution with (g−1)(t²−t+2) degrees of freedom (where g is the number of groups and t is the number of criteria). If −21nλ is greater than the critical value of the χ² distribution, then the null hypothesis is rejected and the groups are said to differ significantly. Estimated judgment matrices are calculated for each group and used in subsequent analysis and decision-making. If the null hypothesis is accepted (i.e. the groups are not significantly different), then the judgments for all respondents are used to calculate an estimate of the Judgment matrix to be used in any further analysis.

To illustrate the statistical process described above, we will consider an example of only three criteria and ten respondents is considered. The three buying criteria for the product in our study are cost (C), function (F) and aesthetics(A). Each respondent is asked to compare the relative importance of these three criteria using pairwise comparisons (cost vs. function, cost vs. aesthetics and function vs. aesthetics). Table 1 shows example results of the comparisons from each respondent. Fractions indicate that the order of preference for that comparison was reversed. For instance, Respondent 5 indicated that function was more important than cost by 2.

TABLE 1
Comparison Data

| | | | Function |
|---|---|---|---|
| | Cost vs. | Cost vs. | vs. |
| Respondent | Function | Aesthetics | Aesthetics |
| 1 | 4 | 6 | 3 |
| 2 | 3 | 5 | 2 |
| 3 | 5 | 7 | 4 |
| 4 | 2 | 4 | 3 |
| 5 | 1/2 | 3 | 5 |
| 6 | 3 | 7 | 5 |
| 7 | 1/3 | 3 | 5 |
| 8 | 2 | 4 | 7 |
| 9 | 1/2 | 5 | 6 |
| 10 | 4 | 7 | 5 |

In addition to the comparison data, the example respondents also provided some demographic data including age group. For this example, Respondents 1 through 6 belonged to one age group and the rest belonged to another age group. The statistical process is used to determine if the weights of the three buying criteria for each group are significantly different or not.

In order to calculate the likelihood ratio statistic, λ, \hat{μ}ᵢⱼ^{(u)} must be calculated from Equation (2) for each group and the overall set. These are then used to calculate the entries to the dispersion matrices from Equation (3) which are subsequently used in calculating the maximum likelihood estimates of the eigenvalues, m and n, of the dispersion matrices. Table 2 shows these results:

TABLE 2
Maximum Likelihood Estimates for
Parameters of the Likelihood Function.

| | Group | Group | |
|---|---|---|---|
| | 1 | 2 | All |
| \overline{y}₁₂ | 0.865 | 0.072 | 0.548 |
| \overline{y}₁₃ | 1.630 | 1.510 | 1.582 |
| \overline{y}₂₃ | 1.249 | 1.739 | 1.445 |
| \hat{m} | 0.998 | 0.779 | 0.687 |
| \hat{n} | 3.126 | 1.372 | 2.361 |

These values are used to calculate the estimates of the likelihood functions for the null and alternative hypotheses. The likelihood ratio statistic, λ, is their ratio. Calculating—21nλ yields a value of 19.673. This is compared to the critical values of the χ² distribution for (g−1)(t²−t+2)=8 degrees of freedom at the 0.90, 0.95 and 0.99 fractiles (13.362, 15.507, and 20.090, respectively). In this case, the null hypothesis can be rejected at the 90% and 95% confidence levels (in other words, consider the groups to be significantly different), but not at the 99% level.

If less than 99% confidence can be accepted and the two groups are considered as having significantly different buying criteria weights, the off-diagonal entries to the estimated judgment matrices for each group is calculated. The results of this calculation are given in the Table 3.

TABLE 3
Estimated Judgements

| | | | Function vs. |
|---|---|---|---|
| | Cost vs. Function | Cost vs. Aesthetics | Aesthetics |
| Group 1 | 2.70 | 5.80 | 3.96 |
| Group 2 | 1.30 | 5.47 | 6.88 |

Calculating the weights of the criteria from this data results in the graphs illustrated in FIGS. 6A and 6B.

Group 1 considers cost to be more than twice as important as function whereas Group 2 considers these two criteria as almost equal. If, on the other hand, less than 99% confidence cannot be accepted, the off-diagonal entries to the estimated matrix for the judgments of all respondents is calculated, resulting in Table 4 and FIG. 6C.

TABLE 4
Estimated Judgements of All Respondents Combined

| | | | Function vs. |
|---|---|---|---|
| | Cost vs. Function | Cost vs. Aesthetics | Aesthetics |
| All | 2.09 | 5.87 | 5.12 |
| Respondents | | | |

There are needed modifications to the general case developed by Basak for the reciprocal matrix to simplify the calculations of the maximum likelihood estimates. To begin with, if aᵢⱼ^{uk}=1/aᵢⱼ^{uk}, then there is no degeneracy introduced in the rank of the dispersion matrix, eliminating the need for the transformation of the singular matrix Σ with the matrix P₁ (which, according to Basak, is “somewhat cumbersome”). The entries of the dispersion matrix, Z, for a given group is calculated from:

zᵢⱼ^{(u)}=yᵢⱼ^{(u)}−μᵢⱼ^{(u)};i<j.

Secondly, calculating the estimates for \hat{μ}ᵢⱼ^{(u)}=\overline{y}ᵢⱼᵤ is simplified as follows:

$${\hat{μ}}_{ij}^{( u )} = {\overline{y}}_{ij}^{( u )} = \frac{{\sum }_{k = 1}^{{r}_{a}} ( {y}_{ij}^{uk} - {y}_{ji}^{uk} )}{2 {r}_{a}} .$$

By definition, yᵢⱼ^{uk}=1n aᵢⱼ^{uk} and yⱼᵢ^{uk}=1n aⱼᵢ^{uk}. Substituting yields:

$${\hat{μ}}_{ij}^{( u )} = {\overline{y}}_{ij}^{( u )} = \frac{{\sum }_{k = 1}^{{r}_{a}} ( ln {a}_{ij}^{uk} - ln {a}_{ji}^{uk} )}{2 {r}_{a}} ,$$

By the reciprocal matrix assumption, aⱼᵢ^{uk}=1/aᵢⱼ^{uk} and 1n aⱼᵢ^{uk}=−1n aᵢⱼ^{uk}. Substituting yields:

$${\hat{μ}}_{ij}^{( u )} = {\overline{y}}_{ij}^{( u )} = \frac{{\sum }_{k = 1}^{{r}_{a}} [ ln {a}_{ij}^{uk} - ( - ln {a}_{ji}^{uk} ) ]}{2 {r}_{a}} ,$$

which simplifies to:

$${\hat{μ}}_{ij}^{( u )} = {\overline{y}}_{ij}^{( u )} = \frac{{\sum }_{k = 1}^{{r}_{a}} ln {a}_{ij}^{uk}}{{r}_{a}} ,$$

FIG. 7 is a diagram illustrating the flow through the best-in-class module 20 of FIG. 1. Listen criteria 108 from the listen module 16 are used in criteria evaluation step 110. At step 110, the evaluation is performed by defining and prioritizing the listen criteria 108 according to customer service requirements 112. Ideally, users will use the priorities gathered by using the listen module 16 with actual customers. Each of the listen criteria 108 can be translated into technical criteria that allow the organization to meet each of the listen criteria 108 through a product or service. At step 114, scales are developed for rating each of the technical criteria using the scale-maker tool. The scales are assigned to criteria to produce a ratings sheet 116 to rate the customer's perception of each sub-organization, such as, for example, a business unit or a location, as to how well it is doing against the competitor that the customer identifies as the best of breed competition. The ratings sheet 116 becomes a questionnaire. The ratings sheet 116 can be input to the charting tool 48. The charting tool 48 can produce graphical outputs such as, for example, an opportunity chart that identifies the most important areas of improvement opportunity for the sub-organization. The charting tool 48 can also produce graphical outputs such as, for example, a spider chart that identifies the most important areas of competitiveness for the sub-organization relative to the best of breed competitor. The best-in-class module 20 is useful, for example, for organizations in any industry for auditing how well the organization is serving its customers.

FIG. 8 is a diagram illustrating the flow through the predict/plan module 22 of FIG. 1. The predict/plan module 22 is a dual hierarchy module that includes a predict module 126 and a plan module 128, which are capable of interacting bidirectionally. The purpose of the predict/plan module 22 is to identify the most important actions and their associated resource costs that will change the balance of power in the organization's favor. Planning is based on predicting the central player's future in terms of scenarios so that the central player's actions address the most likely actions of other important market players. The scenarios can be any type of appropriate scenarios such as, for example, varying degrees of optimism and pessimism. The players in a market collectively mold the future by their actions and the actions of each player can be determined with a great deal of certainty if the priorities of each player are known, i.e. what is driving each player to act. Knowing the priorities and having estimated the power of each player in the marketplace on the future of the central player, the user can plan action items by time period to address the drivers of the players that have the most impact on the future of the central player.

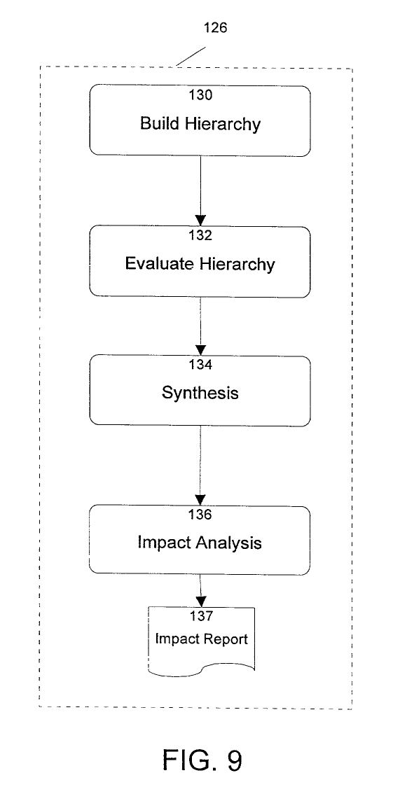

FIG. 9 is a diagram illustrating the flow through the predict module 126 of FIG. 8. The predict module 126 assists the central player in surveying it's the user's playing field in each market. Each market segment is analyzed independently to understand the central player's future in the specific segment relative to other players in the segment. At step 130, a hierarchy is built by defining the players that will impact the future success of the organization in the marketplace. The players can include, for example, the user or the user organization itself, its prototypical customer, its prototypical supplier, its prototypical competitor, and external forces impacting the marketplace. Strategic drivers that drive each player are identified and associated with each player. Scenarios are identified and the likelihood of each scenario is then associated with each driver.

At step 132, the hierarchy is evaluated. At a first level in step 132, the relative impact of each player on the future of the user or user organization is evaluated by pairwise comparison. At a second level in step 132, the relative importance (priority) of each driver of each respective player is evaluated by pairwise comparison. At a third level in step 132, the likelihood priority of each scenario in light of how successful the player is expected to be and how the success of each of the driver is expected to impact the future of the central player is evaluated.

At step 134, a synthesis analysis is performed on the hierarchy to determine the overall likelihood of the scenarios, given the expectations for both the impact and the success of each driver, the relative importance of each driver to each respective player, and the relative impact of the players on the future.

At step 136, an impact analysis is performed to mathematically determine which drivers in the marketplace have the most impact on the organization's future and the amount of contribution of these important drivers on each of the scenarios. Organizations typically want to address the market drivers that contribute 80% of the impact to the future. This can be done by considering only those drivers that have an impact on a scenario of some minimum value that can be, for example, 2%. The minimum impact value can be calculated from the threshold value. This value filters in only those drivers that impact on one or more scenarios so as to be in the group of drivers with the higher impact values that collectively contribute 80% of the impact on the organization's future. The impact report 137 is built from the following calculations. First, a hidden synthesis is calculated to identify the relative importance of the scenarios. Ordinarily, the synthesis process combines leaf elements having the same name so that, for example, a synthesis report of the likelihood of scenarios shows only one bar for each of the four scenarios even though the hierarchy consists of a set of four scenarios that are repeated under each driver of each player in such a manner that relative likelihood values can be recorded for each driver of each player. The hidden synthesis does not perform this combination process. Therefore, the hidden synthesis consists of an explicit list of all the leaf scenario sub-elements sorted by global weight. Thus, the scenario sub-element with the largest global weight can be selected and in an iterative mode the global weight of the next sub-element in the list can be selected until a value of 0.8 is reached. The remaining sub-elements are ignored so that an impact report can be built from the list of sub-elements that contribute 80% of the value to the organization's future. Typically, this filtering process eliminates from consideration about half of the leaf sub-element values whose contribution to the planning process is not significant. Taking the remaining sub-elements whose values are significant, the impact report is built player by player, listing each driver that has a leaf scenario sub-element of significant value with each significant scenario sub-element value in the appropriate scenario column. This information is presented in the impact report 137.

The impact report 137 has a brainstorm list to help the user gather potential action items that could be taken to address (counter or enhance) the impact of each player for each scenario. There can be, for example, four brainstorm lists, one for each of four respective planning time frames. The time frames can be identified as, for example, “low hanging fruit,” “high hanging fruit,” “long term (strategy)” and “blue sky.” The timing for each of these is determined by the organization. For example, in a stable and basic industry such as steel-making, the low hanging fruit may be 2 years and the blue sky may be 20 years whereas in the computer industry, the low hanging fruit may be 4 to 6 months and the blue sky may be only 3 years. The user must define the time frames as appropriate for the planning exercise. The user can then use the presentation of the impact report 137 to brainstorm actions in the time frames that will address issues associated with addressing the impact of the drivers on the future of the user. When the user uses the suggested scenarios of “big frown”, “little frown”, “little smile”, and “big smile”, the user should associate actions that address impact values in the two optimism columns with the brainstorm list for the low hanging fruit time frame. Furthermore, the user should associate actions that address impact values in the two pessimism columns with the brainstorm list for the high hanging fruit time frame.

While the first two time frames (low hanging fruit and high hanging fruit) are focused on what the organization is doing today and on logical improvements to overcome problems related to what the organization is doing today, the last two time frames (long term and blue sky) focus on beyond what is done today, and reflect long-range planning. The long term time frame represents the “seeds to be planted” or strategy portion of planning, and reflects the time frame traditionally used by organizations for strategic planning cycles. The blue sky time frame represents “seeds to be invented” and, in many organizations, represents research and development efforts, setting the direction for the actions to be identified in the strategy or long term planning time frame.

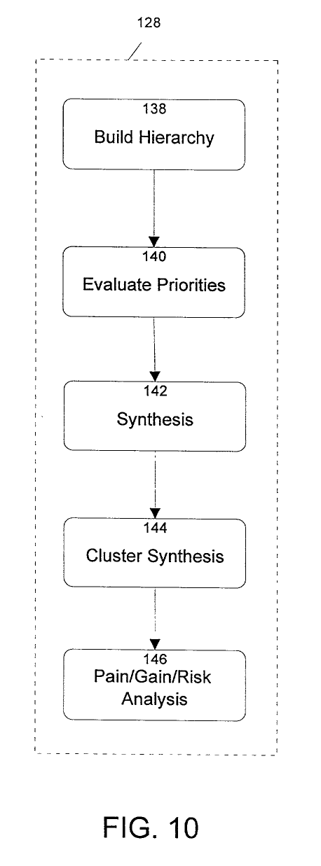

FIG. 10 is a diagram illustrating the flow through the plan module of FIG. 8. At step 138, a hierarchy is built. The top level of the hierarchy is the four time frames identified earlier as time-line themes. The potential activities identified in the brainstorming of the impact analysis step 136 of FIG. 10 can be used as a catalyst for naming at least the low hanging fruit and the high hanging fruit time frames. The names of these time frames are called time-line themes. The associated brainstorm lists will be used later as a catalyst in selecting action items that address strengths and weaknesses for the associated time line theme. Usually, the names and potential actions for the strategy and blue sky time line themes must be brainstormed. These time frames may be done, for example, after the analysis of the first two time frames is completed. The blue sky theme should be addressed, for example, before the long term theme. The second layer of the hierarchy is for strengths and weaknesses. For each time-line theme, the user identifies, for example, three strengths and three weaknesses for performance in the respective time-line. At the third level, the user identifies, for example, two actions that address each of the respective strengths and weaknesses.

At step 140, the priorities are evaluated. At the third level, the user determines the relative importance of each action to enhance the respective strength, or if it is a weakness, to overcome it. At the second level, the user determines the relative importance of enhancing strengths or overcoming weaknesses for the respective time-line theme. At the top, the user identifies the relative priority of resources to be applied during each time frame. For example, 15% can be applied to low hanging fruit, 25% to high hanging fruit, 55% to long term and 5% to blue sky or R&D activities.

At step 142, a synthesis analysis is performed of the hierarchy to yield a prioritized list of relative importance of each action item to the goal of the organization's desired future. The user can elect to execute the allocate module 24 at this point, however it is recommended that the user use the cluster synthesis tool 144 prior to performing resource allocation.

A cluster synthesis analysis is performed at step 144. The purpose of this step is two-fold. First, it is common for users to have identified actions under different strengths and weaknesses and under different time-line themes that are named differently but which are in fact the same. At step 144 the user consolidates similar actions. Second, the cluster synthesis analysis analyzes whether the planning process has introduced a change in the drivers of the organization. At step 144, action items can be grouped into new categories. For example, the user could use the tool to classify like actions into like categories. These categories are the new drivers for the organization. The new drivers can be automatically fed back into the predict module 126 to determine if the identified actions will lead to a prediction of a positive shift of the balance of power in favor of the organization. If a negative shift in the balance is predicted, the user needs to reexamine the actions identified in the plan hierarchy because some of these actions are leading to pessimism as opposed to optimism for the future. Alternatively, the user could use functional departments as the categories. This is useful for assigning actions to, for example, departments within the organization.

A pain/gain/risk analysis is performed at step 146. The synthesis of actions represents the gain of each action to the organization. The synthesis of actions can be transferred into a spreadsheet in a workbook tool. This function formats a table with, for example, columns for action name, gain (synthesis global weight), pain (user estimate of cost), normalized pain (spreadsheet calculation based on the cost estimates), risk (user estimate of the likelihood that an action will be successful) and gain/pain/risk index (calculation based on the formula PGR_{index}=((Gain*Risk)/Pain)). The action names with their associated weights and all the formulas needed to calculate a gain/pain/risk index are transferred. The user then enters estimates of cost for pain and estimates of likelihood or risk, for each action. All of the calculations are based upon ratio mathematics. The user may elect not to consider all of the actions on the action list, and may filter the action list so as to consider, for example, only those actions that contribute the top 80% of the gain. Therefore, the gain values used in PGR_{index}=((Gain*Risk)/Pain) formula must be normalized. Likewise, the pain or cost values and the risk values must be normalized. Charting and sorting functions are provided to enhance the report output. The user can elect to implement, for example, action programs that provide the best PGR_{index} values.

FIG. 11 is a diagram illustrating the flow through the allocate module 24 of FIG. 1. The allocate module 24 is used to assist the organization in performing a more detailed analysis of resource allocation decisions than that which is provided in the PGR_{index} analysis. The allocate module 24 ties the organization's resource allocation decisions to its strategies on a more global level, identifying those action programs that contribute the most to multiple business units, market segments and product lines. The allocation of limited resources to projects and proposals depends on how well these alternatives address the organization's strategies in the markets in which it participates. The relative attractiveness of the markets to the organization and the relative importance of the strategies in each market, are also part of the allocation decision. The final attractiveness of an alternative is a ratio of the benefit derived from pursuing the alternative (how well it addresses the strategies), the cost of pursuing the alternative (in terms of resources needed to accomplish it), and its probability of success or risk of failure.

At step 148, the market segments are prioritized according to their attractiveness to the organization as derived in the portfolio module 18 at a first level. At step 150, the strategies of the organization in each of the market segments are prioritized according to their importance to the organization as derived from the predict/plan module 22 at a second level.

At step 152, if necessary, a third level (a level of translation) can be created to identify how different disciplines in the organization can support the strategies. For example, for an allocation decision involving R&D projects, the third level will reflect technologies needed to support the strategies.

Finally, at step 154 alternatives are evaluated against the strategies or the “technical characteristics” to ensure that they meet the organizational strategies across the markets. Separate models may be built to determine the cost and risk of alternatives.

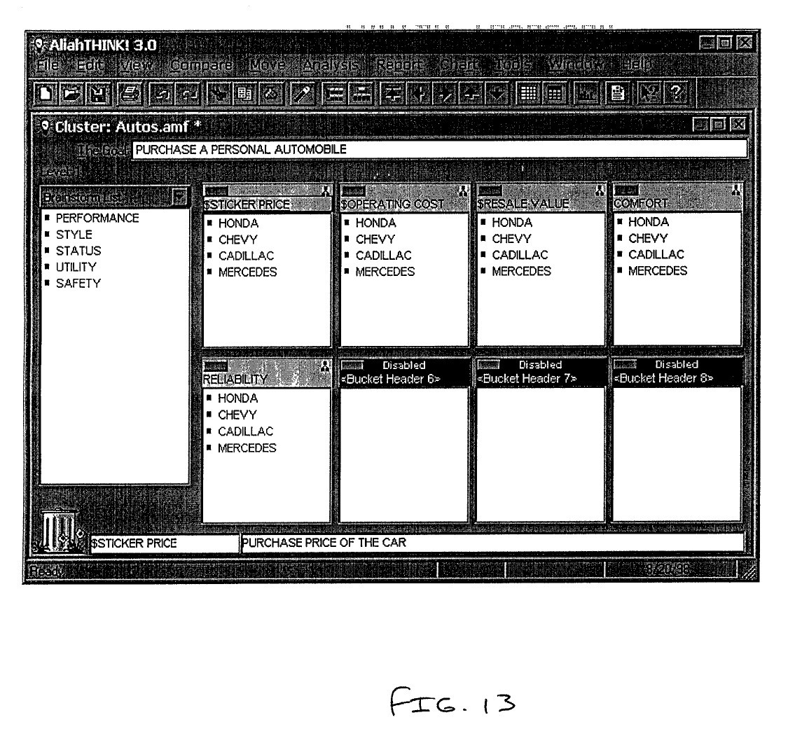

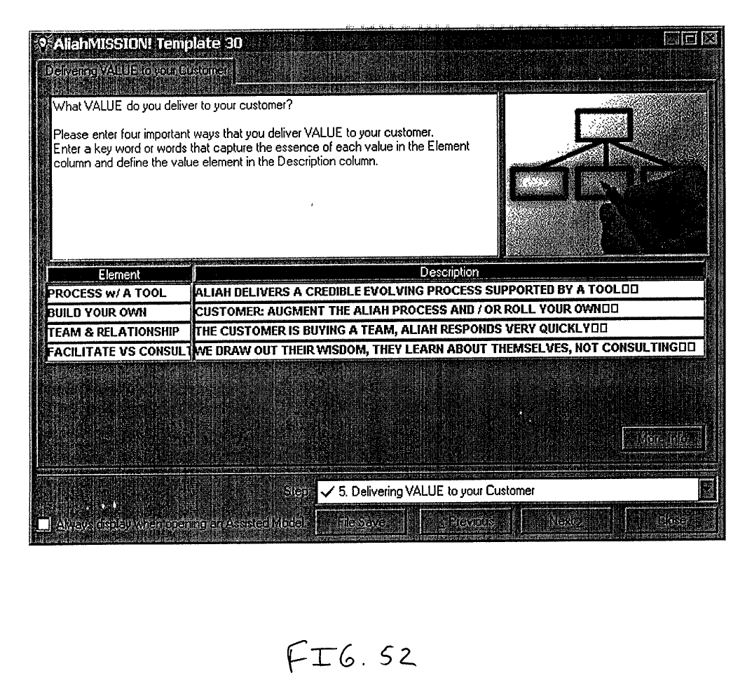

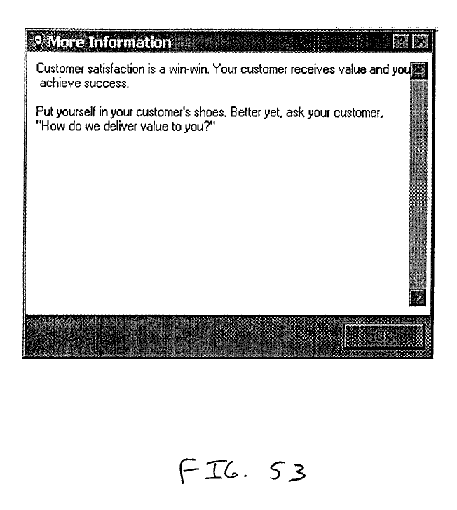

FIGS. 12-57 are screen printouts illustrating an example of the operation of an embodiment of the system 10 of FIG. 1.

FIG. 12 is a screen printout illustrating a business development process similar to the process flow illustrated in FIG. 2. The business development process describes how analysis processes, including, for example portfolio and predict/plan, are positioned for the user in a larger context, such as for example, of ideation where there are a series of decision gates through which an initial idea must pass from an initial idea to become a product. Functionally, the business development process illustrated in FIG. 12 assists the user in selecting the appropriate decision method at the appropriate stage of development. The business development process also assists the user in managing and reporting on the status of multiple projects in an organization. This example illustrates the concept of buttons on buttons. There are five buttons representing each of the five stages in the example process. There are also buttons on top of each stage button to allow the user to select a specific decision process within that stage, such as, for example, the portfolio process in stage two. The business development process screen illustrated in FIG. 12 can be customized. Customization can include, for example, screen title, screen background, button graphics, number of stages, stage names, number of decision processes and process names.

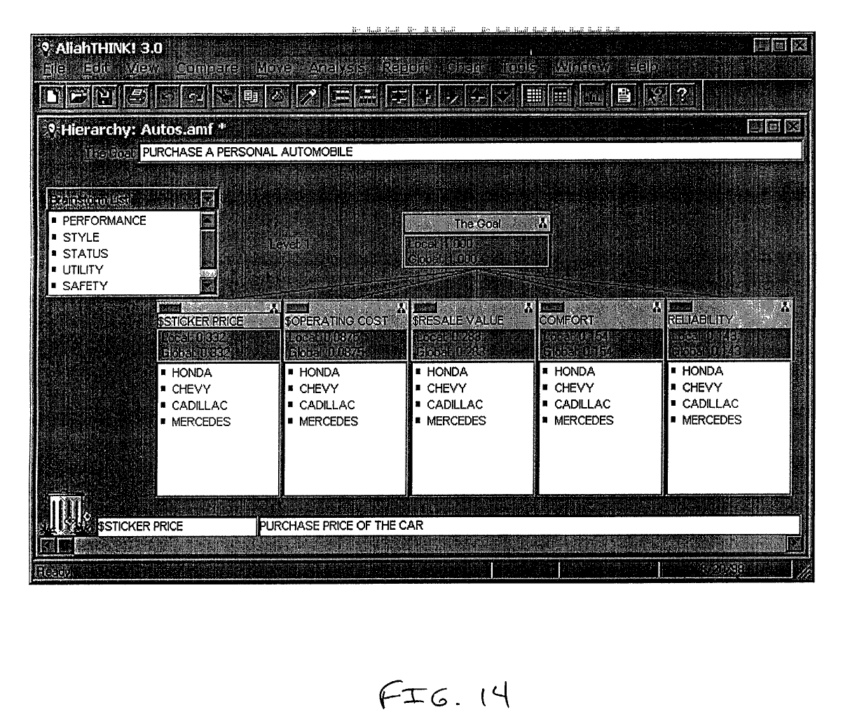

FIG. 13 is a screen printout illustrating an example decision hierarchy for the selection of an automobile during the execution of the hierarchy engine 14. The criteria elements are those in the yellow header boxes and the alternatives are duplicated under each header criterion. This hierarchy illustrates the structure of evaluating alternatives as sub-criteria in the hierarchy as opposed to rating the alternatives in a ratings sheet. This screen printout illustrates a cluster display mode for building a hierarchy. In this screen, the user may enter up to eight criteria elements under the goal and up to eight sub-criteria elements under each criterion element. The user can also enter criteria elements into a brainstorm list. Some decision models have several brainstorm lists. When the user selects the brainstorm list header, a drop-down list of available brainstorm lists appears allowing the user to make a selection. Each element has an element name and an element description. These are edited in the element edit area at the bottom of the window. A trash can is provided as a depository for elements to be deleted. The operation of this is similar to that of the recycle bin of Windows95. The trash can is animated to open and close for element drag and drop and is connected to a special brainstorm list called Trash. Extensive drag and drop, cut, copy and paste functionality is also provided for user interface convenience.

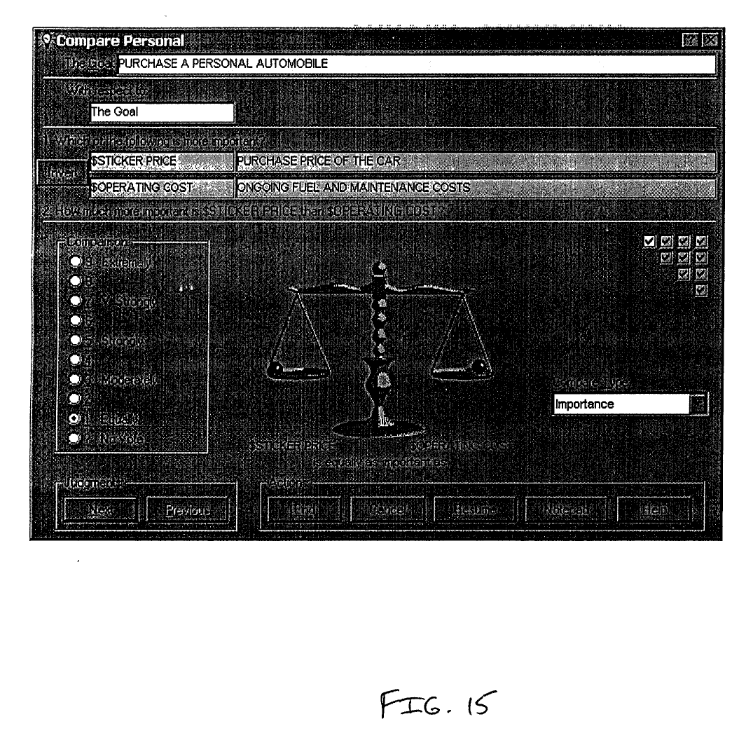

FIG. 14 is a screen printout illustrating the hierarchy mode of the cluster screen of FIG. 13. In the hierarchy view, the user sees the hierarchy structure eliminating the display of header elements that are disabled. Other than display format, the functionality is the same as that provided by the cluster view.

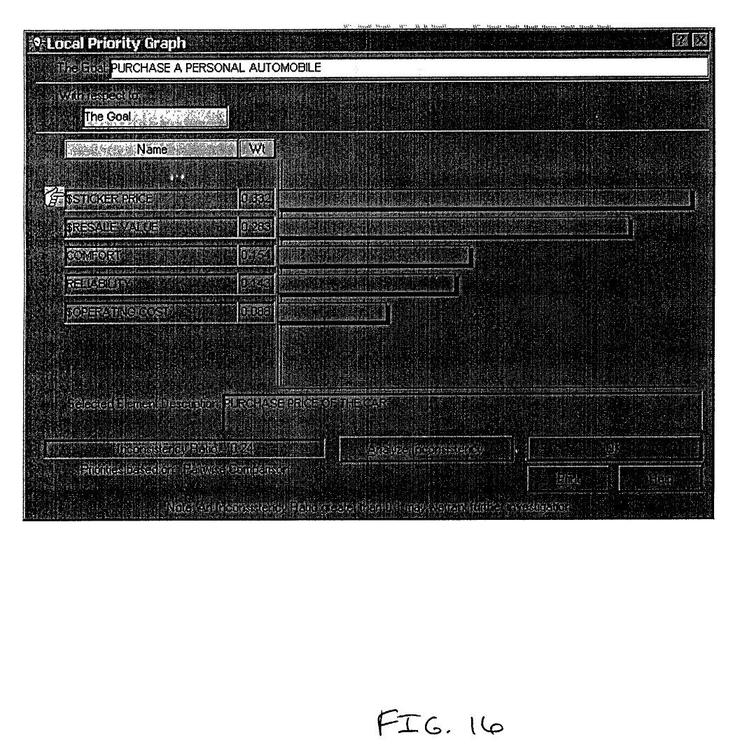

FIG. 15 is a screen printout illustrating the screen for data entry of element pairwise comparisons. This screen sequences through all pairs of comparisons to build the comparison matrix that will yield the element weights per the eigenvector calculation of AHP. As the user makes judgments of the intensity of feeling, the scale is animated to provide a visual of the selected intensity. When the user clicks the end button this calculation is performed and the hierarchy weights are updated.

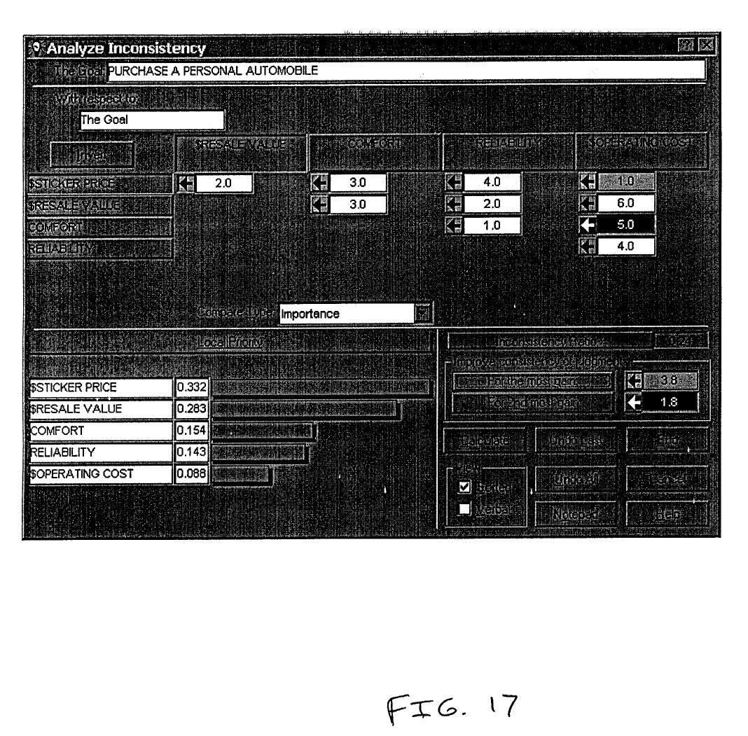

FIG. 16 is a screen printout illustrating a priority graph. The priority graph shows a prioritized Pareto-like graph of the local weights of a plex. This graph is displayed automatically after the user completes a comparison process. The user can choose to display this graph from the menu.

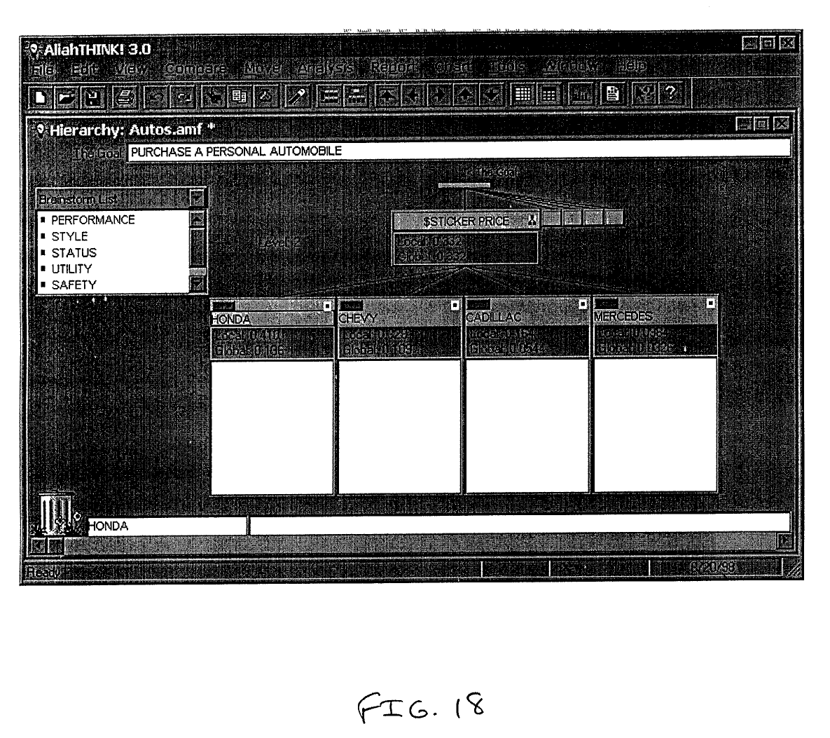

FIG. 17 is a screen printout illustrating the inconsistency analysis feature of the hierarchy engine 14. In this screen, the user entered comparison matrix is sorted to assist the user in seeing areas of comparison inconsistency. Inconsistency can appear as an inconsistent reversal of one or more judgments or it can appear as an inconsistent intensity of judgment in one or more comparisons. The user can analyze the impact of making changes in the judgment matrix on the priority graph and on the inconsistency ratio.

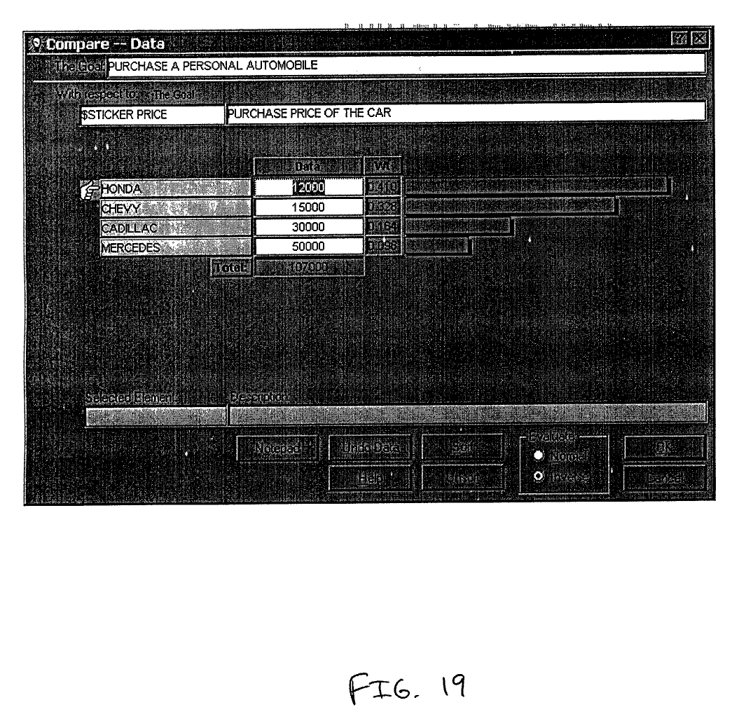

FIG. 18 is a screen printout illustrating the sub-element hierarchy under the sticker price element under the goal. Some decision-making hierarchies are several levels deep. Move buttons provide a way to navigate the hierarchy. Alternatively, the user can elect to find a particular element by using a map feature (not illustrated) which allows the user to view and print the entire hierarchy in either horizontal or vertical orientation.

FIG. 19 is a screen printout illustrating the ability to enter data comparisons. In this example, the criterion sticker price is weighted by the relative prices of the alternatives. In this case, the user selected an inverted data calculation because the lower sticker price value is the more preferable.

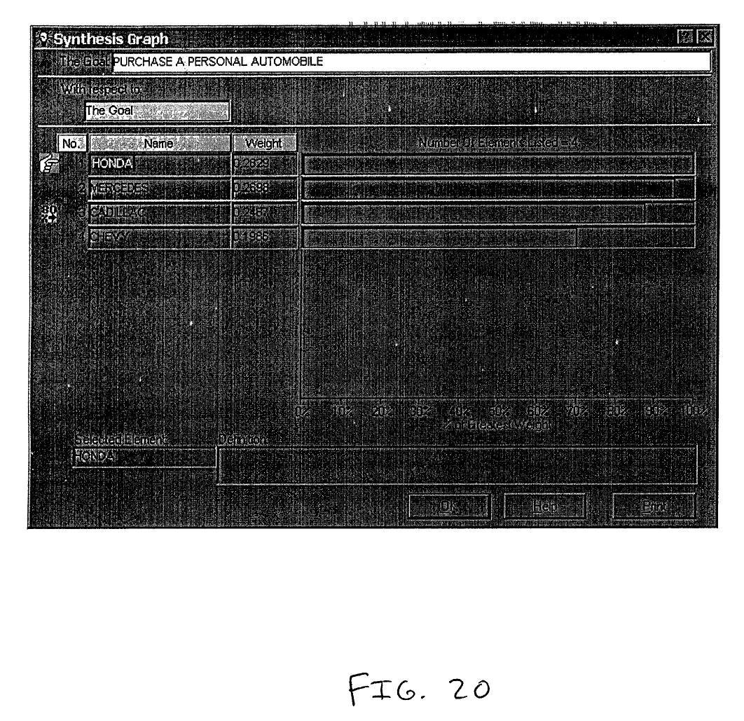

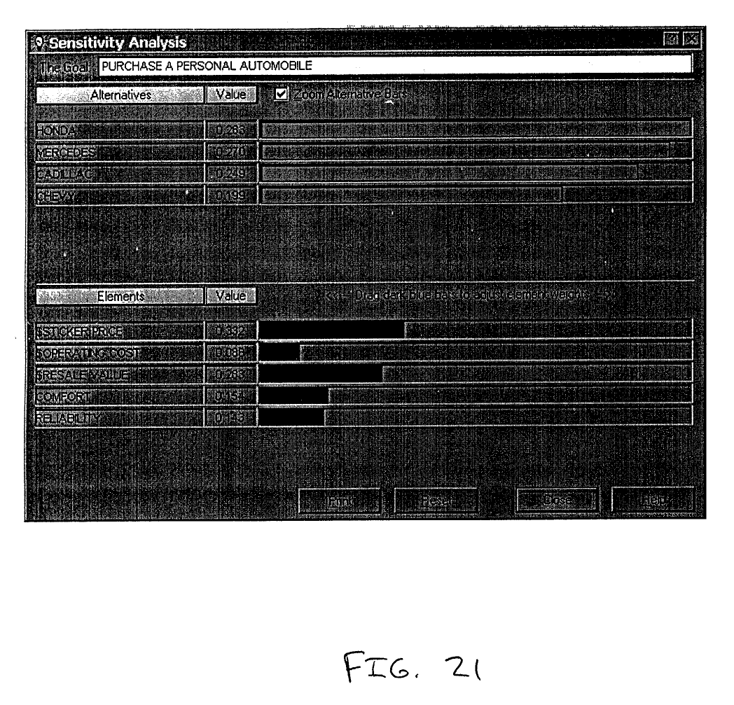

FIG. 20 is a screen printout illustrating a synthesis graph. In the automobile selection model, the alternatives are in the leaf element positions, duplicated under each criterion under the goal. The synthesis calculation combines the global weights of each alternative in the synthesis graph presentation.

FIG. 21 is a screen printout illustrating a sensitivity graph options. This is an example of a dynamic sensitivity graph that allows the user to change the local weights of the criteria under the goal in order to dynamically view the updated weights of the alternatives. A print function is provided so the user can print analysis scenarios.

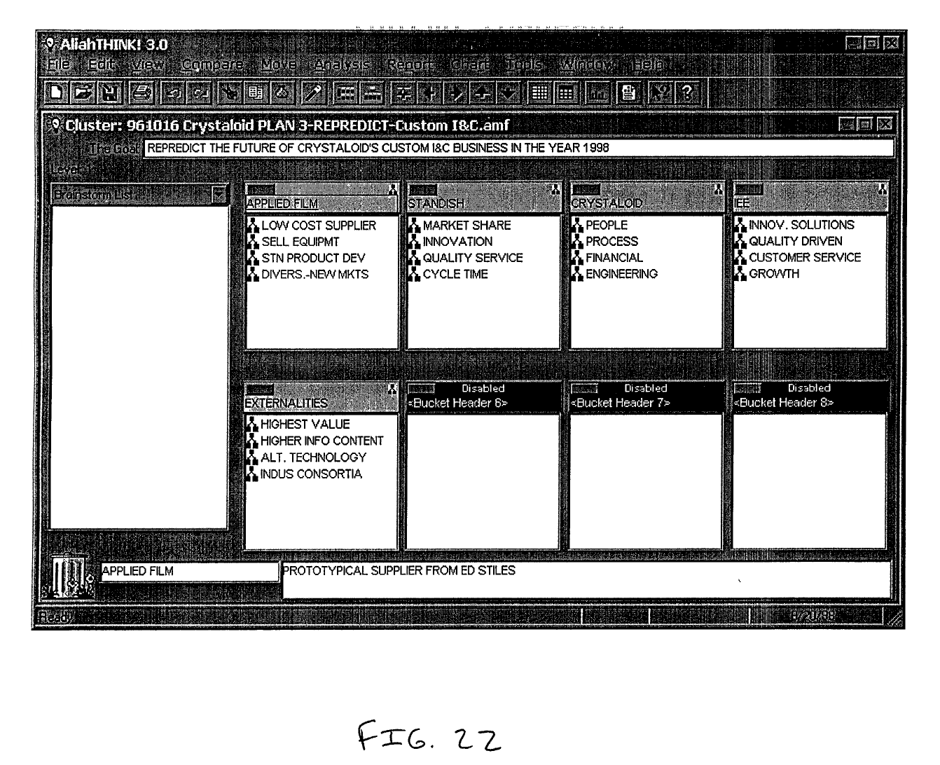

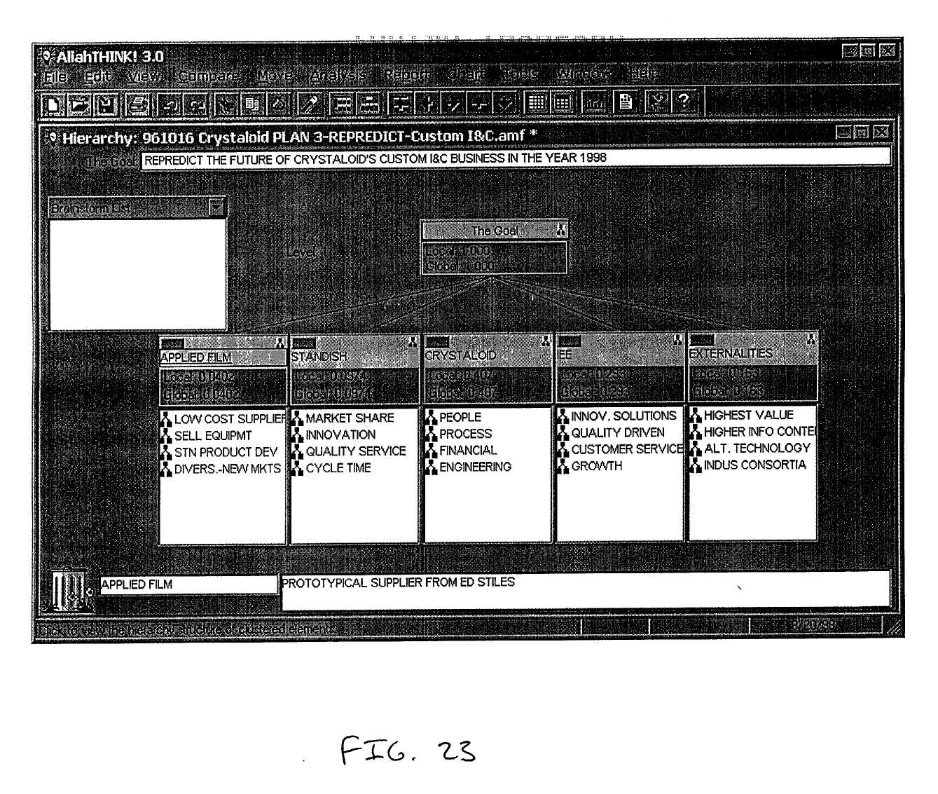

FIG. 22 is a screen printout illustrating a predict analysis hierarchy of the predict/plan module 22 in cluster view.

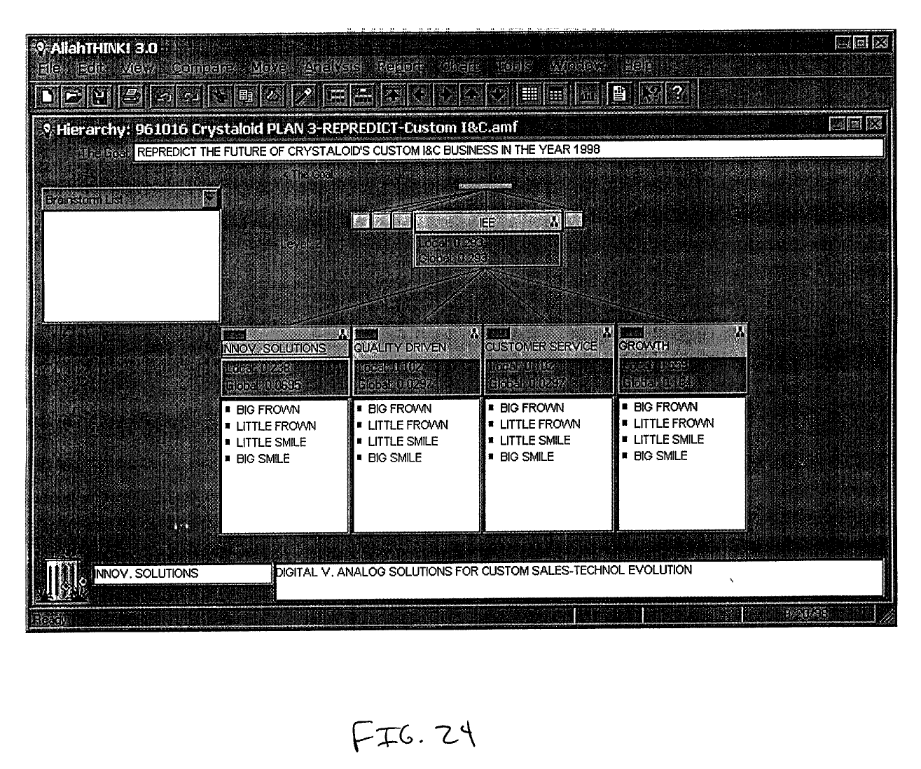

FIG. 23 is a screen printout illustrating a predict analysis hierarchy in hierarchy view. This predict hierarchy is designed to predict the future of the player called Crystaloid. Crystaloid is an organization that is the central player of the planning process and therefore Crystaloid is placed in the middle of the hierarchy. The customer player is placed to the right of the central player. In this case the customer is an organization called IEE. The competitor market player is placed to the left of the central player. In this exercise the competitor of Crystaloid is an organization called Standish. The market player that is the supplier to Crystaloid is placed to the left of the competitor. In this case the supplier is an organization called Applied Film. Crystaloid has externalities that affect its future. Externalities are identified on the right of the hierarchy.

Predicting the future in this decision model has the premise that the principal players in a market make the future happen. Predicting is also predicated on the fact that priorities cause players to act and that these actions either impact the central player in a positive or a negative way. Therefore, the predict hierarchy has a layer below the players where the driving priorities of each respective player are identified. There is a layer below the drivers that assesses the impact of each driver of each player on the future of the central player. The user can use this hierarchy structure to predict the future, for example, of specific business deals and specific projects by selecting specific players that are relevant to the specific deal or of whole market segments or industries by selecting prototypical players.

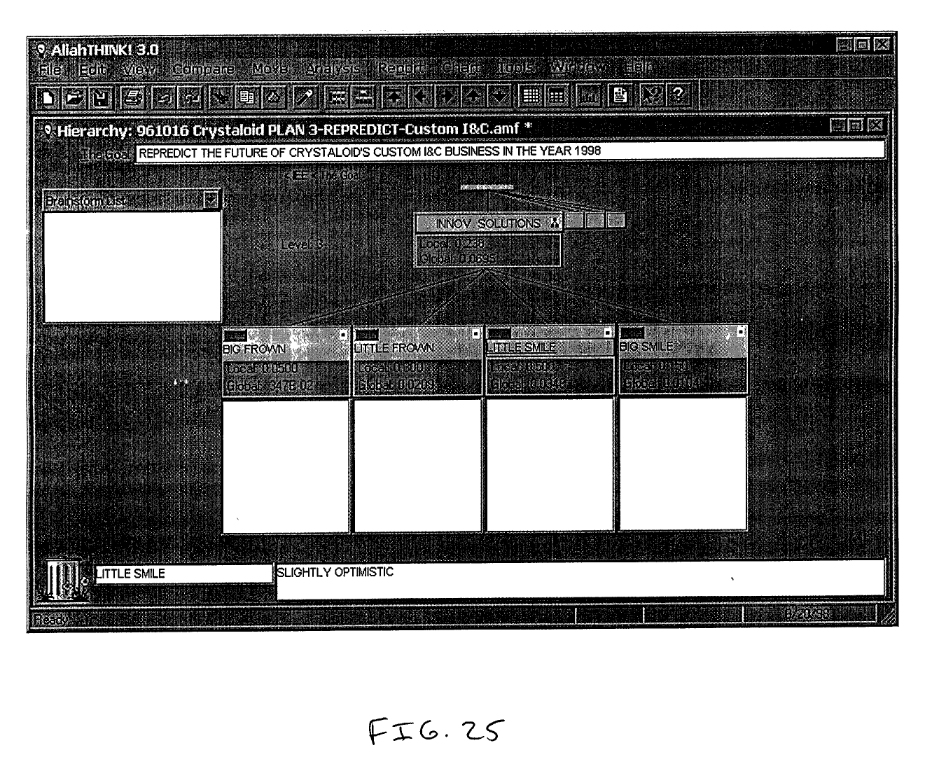

FIG. 24 is a screen printout illustrating the driver level under the customer element IEE. The user navigates to this point by clicking on the customer element in FIG. 23 and then clicking the down arrow navigation button in the toolbar. In this view, the user determines, by comparison, the relative importance of the customer drivers to the customer. This view shows the sub-elements of the customer drivers. In this case, these elements are the scenarios, the likelihood of each the user needs to predict.

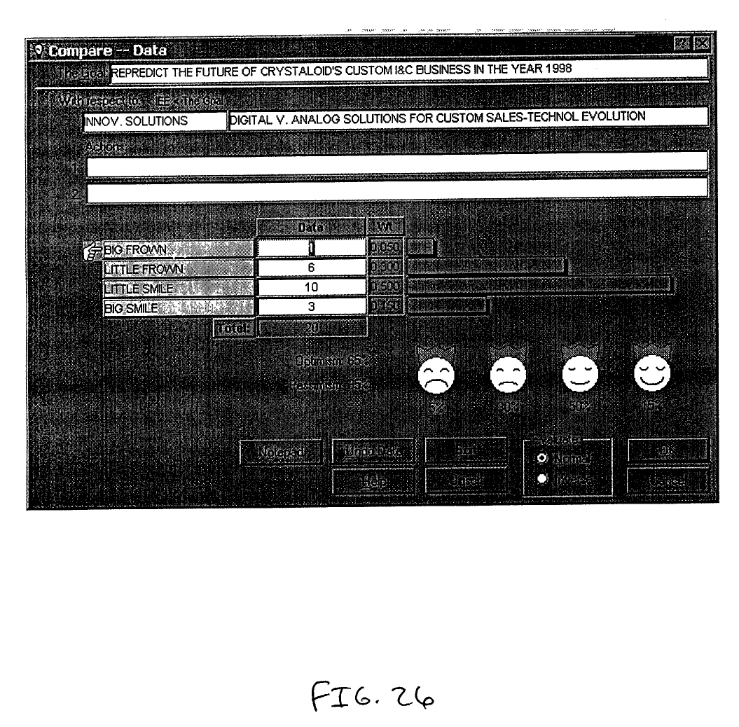

FIG. 25 is a screen printout illustrating the scenario level of the predict hierarchy of the predict/plan module 22. The scenarios shown are under the innovative solutions driver of the customer IEE. The scenarios are compared relative to each driver in such a way as to determine the likelihood of the four scenarios relative to the central player. Each scenario is a predicted outcome on the future of the central player. Therefore, the scenarios are compared as to which scenario is most likely for the central player given that the associated driver is not only important to the associated player, the user must assess the likelihood that the associated player will be successful with this driver.

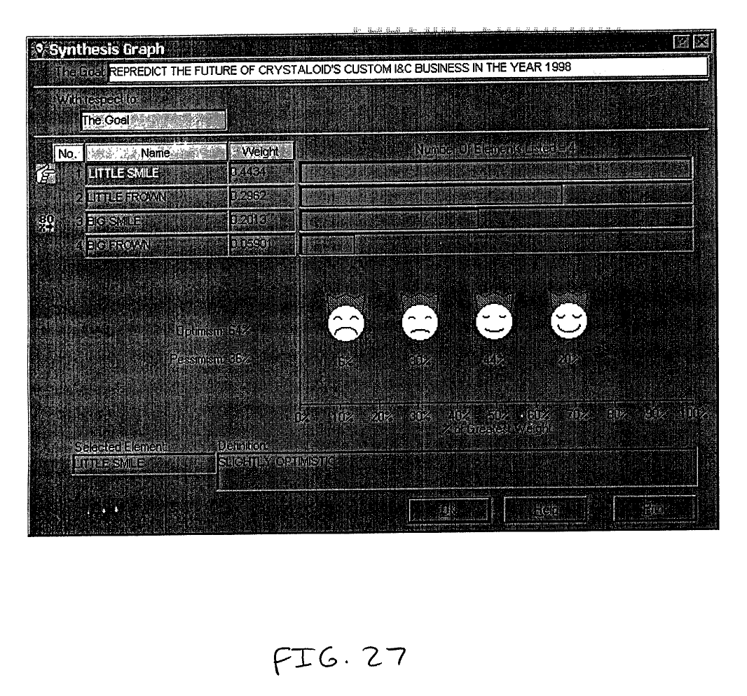

FIG. 26 is a screen printout illustrating the comparison of scenarios. A feature of the predict/plan hierarchy is animated graphic smiley faces that represent the scenarios. The screen also presents a summary of the amount of pessimism and optimism represented by the comparisons. Data comparison is used in the example shown in FIG. 26. The user has the ability to record the actions that the user expects the respective player to take in order to be successful with respect to the respective driver of the player. The ability to record these actions helps the user to assess the relative likelihood of the scenarios.

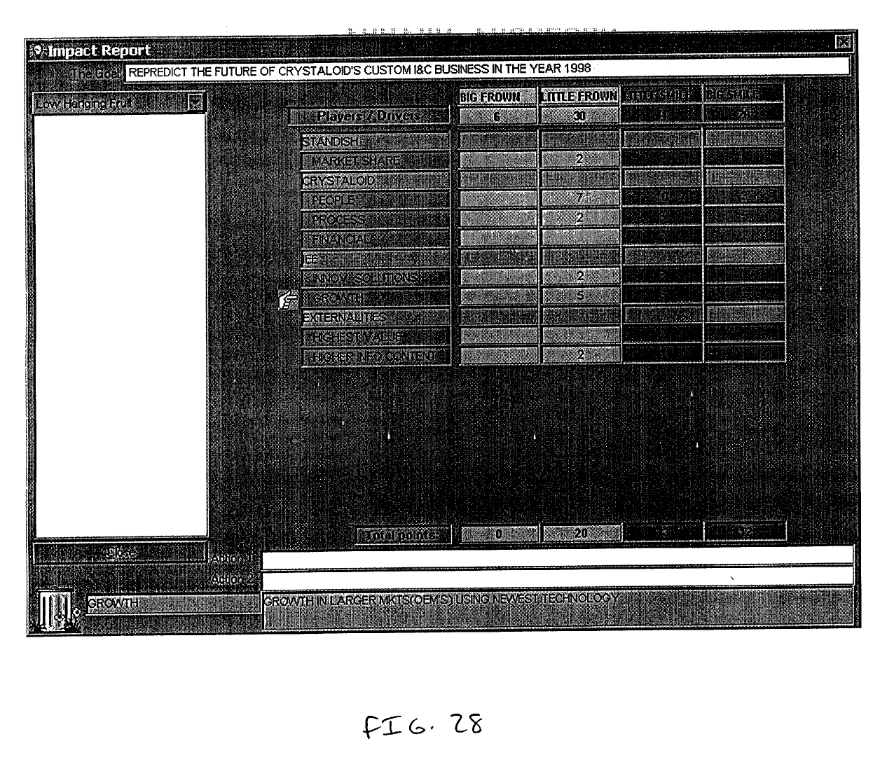

FIG. 27 is a screen printout illustrating the synthesis of the scenarios for the entire hierarchy. This synthesis represents the predicted future of the central player, taking into account the relative impact the user expects each player to have on the future, the relative importance of each driver on each respective player, and the relative likelihood of the scenarios for each driver of each player in the hierarchy. The user may elect to perform a synthesis for each player in the hierarchy in order to assess the impact on the future of the central player of each player. The synthesis graph of a predict hierarchy also indicates animated happy faces with an indication of the amount of optimism and pessimism.

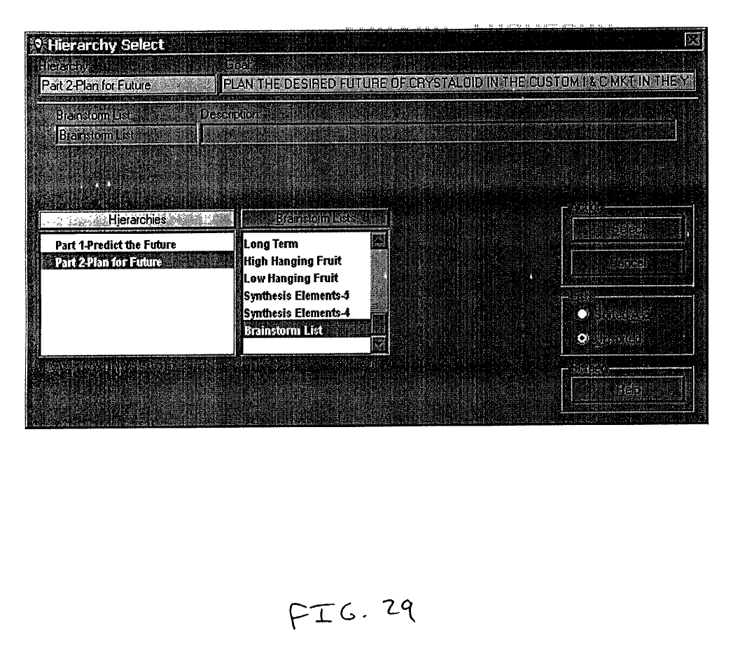

FIG. 28 is a screen printout illustrating the impact report output of the predict hierarchy of the predict/plan module 22. This report indicates the relative impact of each driver on the future of the central player by scenario. Only the scenarios under a driver that have the largest impact are displayed such that approximately 80% of the total impact on the future is indicated. This filtering is done because it eliminates planning for drivers that have only minor impact on the future. Experience has shown that usually only half of the drivers in the model contribute to the top 80% impact on the future. Thus, this filtering is a major time saver and it promotes focus on what is most important. In FIG. 28, the growth driver of the customer is selected. There is much optimism predicted, 10 points out of a possible 100 points. If the user had entered actions during the comparison process earlier, they would be presented here. Because these fields are blank, the user can enter actions in this screen that the customer is likely to take in order to be successful in the growth driver. Determining these actions can greatly assist the user in determining what actions the central player should take in order to be more successful in the future. The impact report has brainstorm lists to record these user action ideas. The Low Hanging Fruit brainstorm list shown is used to record action ideas for the central player that result from an analysis of the optimism in the green columns (Little Smile and Big Smile columns). The High Hanging Fruit brainstorm list (user selected by clicking on the brainstorm list heading) is used to record action ideas for the central player that result from an analysis of the pessimism in the yellow columns (Little Frown and Big Frown columns). These brainstorm lists are available later in the plan hierarchy portion of the process.

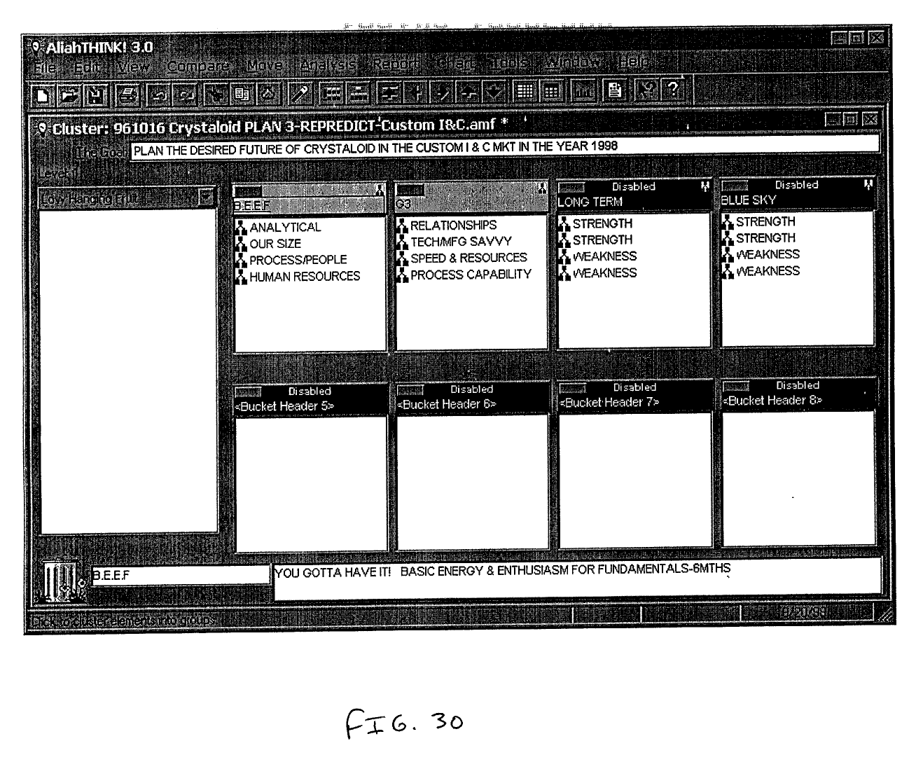

FIG. 29 is a screen printout illustrating the ability to select a specific hierarchy within a decision model file. Certain of the decision processes for planning require more than one hierarchy for analysis, such as, for example, portfolio and predict/plan. This screen also allows the user to select a specific brainstorm list if multiple brainstorm lists are available. A developer mode for this screen (not shown) has additional buttons and editing capabilities that allow a developer to create new hierarchy structures, brainstorm lists and rating sheets.

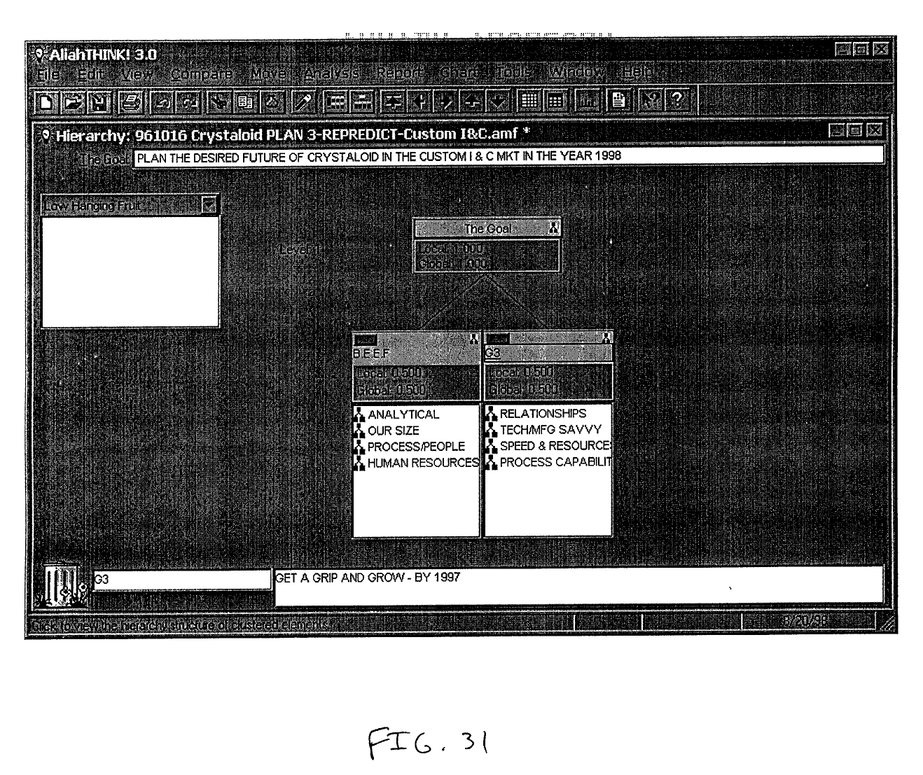

FIG. 30 is a screen printout illustrating the plan side of the Crystoloid predict/plan hierarchy in cluster mode. The purpose of the plan hierarchy is to determine the winning actions that will change the balance of power to the favor of the central player. Actions are planned in, for example, four time frames. The low hanging fruit time frame in this illustration has been given a time frame theme called “B.E.E.F., You gotta have it! Basic Energy & Enthusiasm for Fundamentals-6 mths.” The high hanging fruit time frame has been given the time frame theme “G3, Get a Grip and Grow—by 1997.” Brainstorming the time frame theme names is assisted by having a brainstormed list of potential actions as previously indicated. Planning for the long term and blue sky time frames is optional.

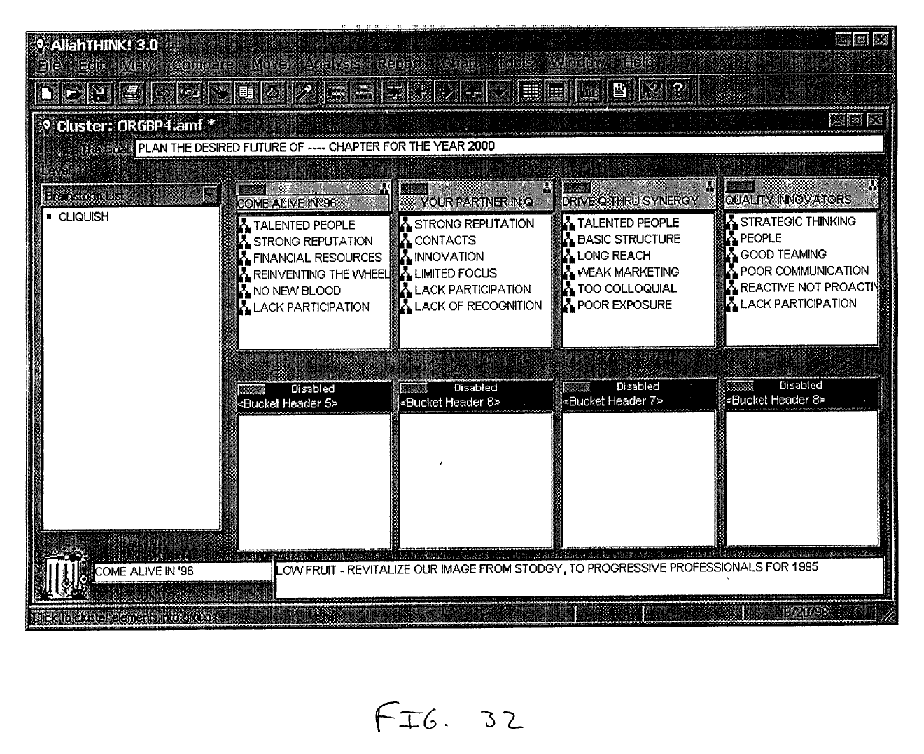

FIG. 31 is a screen printout illustrating the plan side of the Crystoloid predict/plan hierarchy in hierarchy mode. Only the enabled time frames are shown in the hierarchy mode. Under each time frame is a list of two strengths followed by two weaknesses of the organization relative to the time theme.

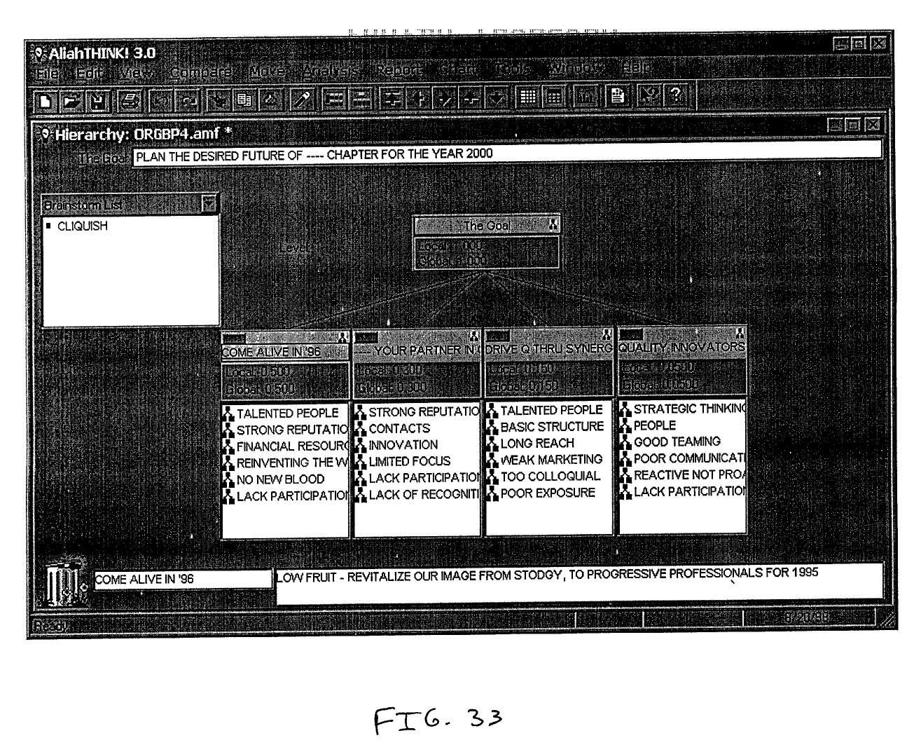

FIG. 32 is a screen printout illustrating another plan hierarchy in cluster mode where all four time frame themes were used. In this hierarchy, there are three strengths followed by three weaknesses.

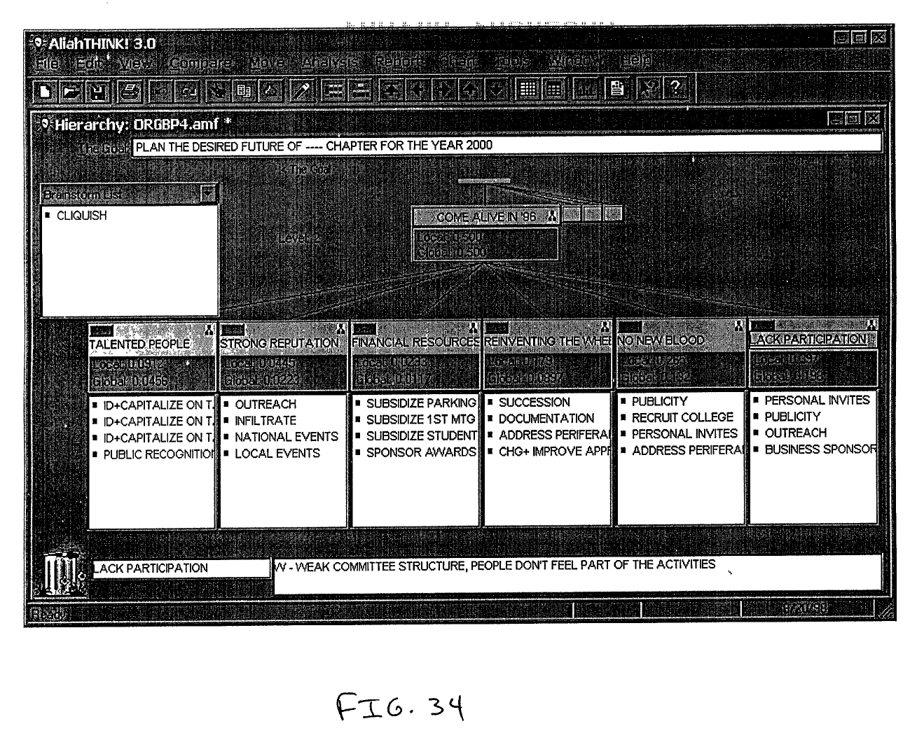

FIG. 33 is a screen printout illustrating the hierarchy of FIG. 32 in hierarchy mode.

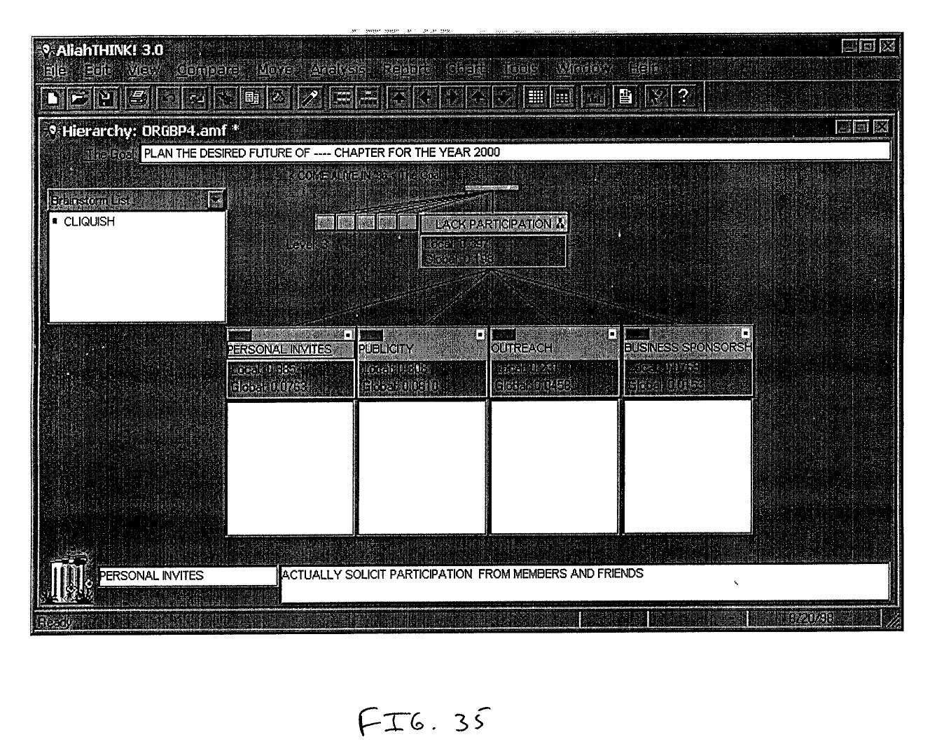

FIG. 34 is a screen printout illustrating the user having navigated down under the “Come Alive in '96” time frame element. In this view, the strengths are on the left and the weaknesses are on the right. The weights indicate that the user priority is mostly to overcome the weakness called lack participation. Underneath this element are four actions that the user feels would overcome this weakness.

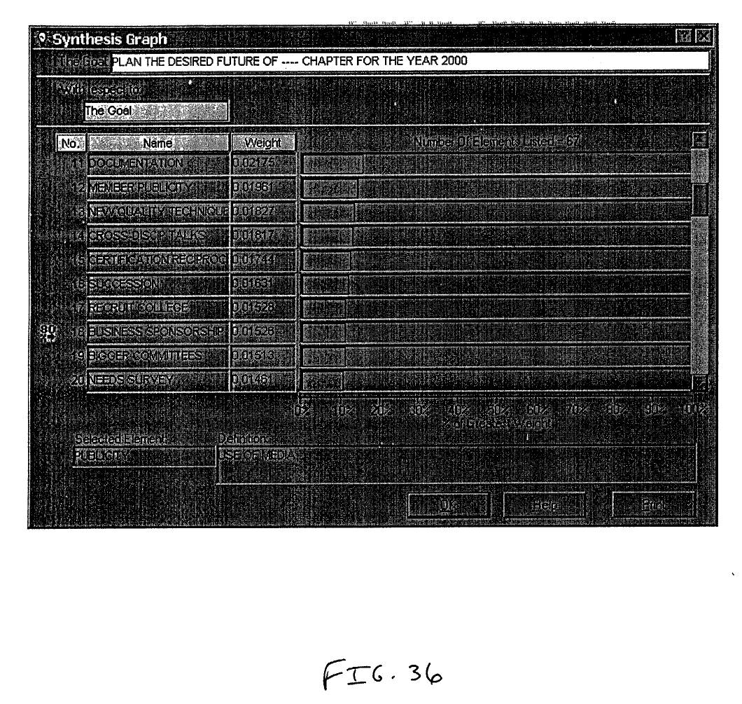

FIG. 35 is a screen printout illustrating the user having navigated down under the lack participation weakness where the priorities of the action programs to address this weakness are indicated.

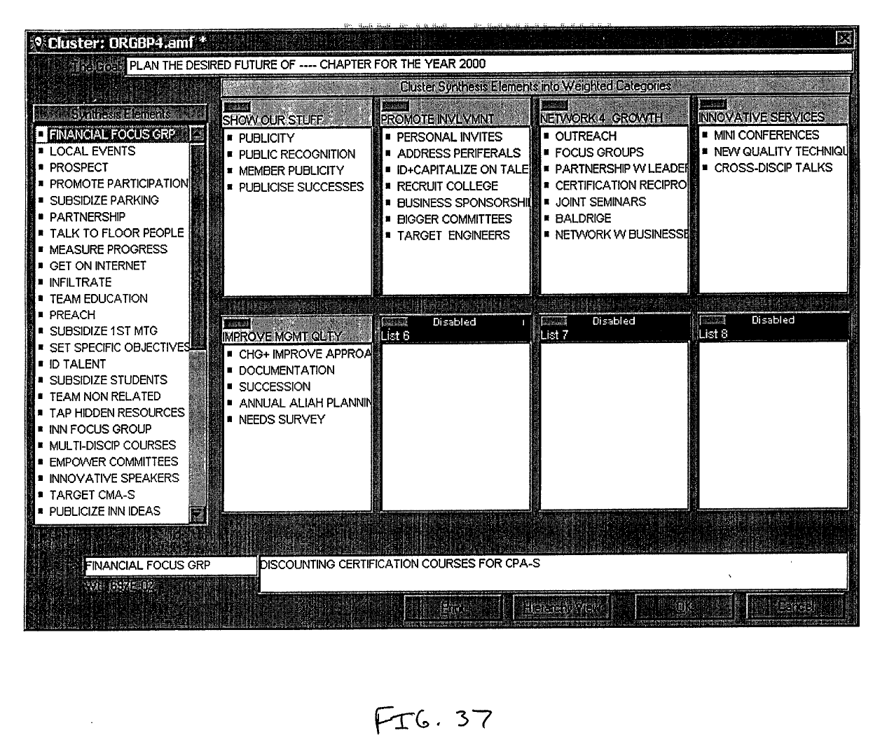

FIG. 36 is a screen printout illustrating the synthesis of all actions identified to address all strengths and all weaknesses in every time frame. This illustration shows the action elements that are below the top ten. There are 67 actions, however, the 80% marker indicates that the user only needs to address eighteen actions in order to get 80% of the benefit.

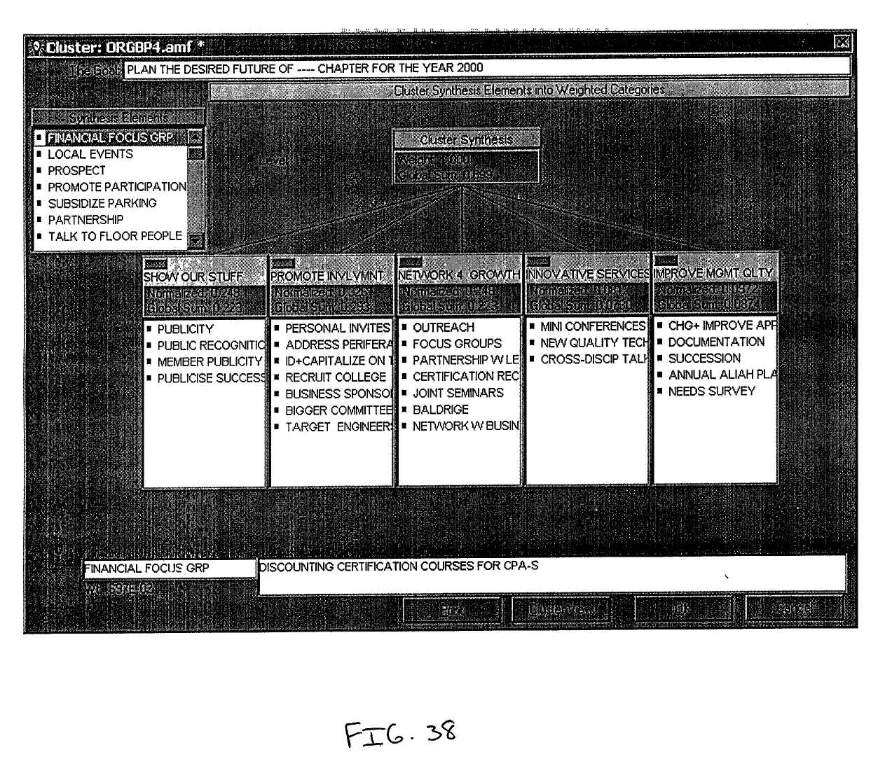

FIG. 37 is a screen printout illustrating the cluster synthesis analysis in cluster mode.

Initially, this screen is blank except for the prioritized list of actions from the previous synthesis of action elements. The user has used this cluster synthesis tool to categorize the top weighted 26 action elements for planning. Categorization takes place by, for example, dragging the top element from the synthesis elements list into the first element under the first bucket. The second element is then dragged into either the first list or the second list depending upon whether the user feels that the second element relates to the first element or not. Dragging and dropping continues in this manner until the user feels that enough of the weight of the synthesis list is accounted for among the categorized action elements. After categorization has been completed, the user then names the categories according to the action elements in each list. The category names are entered into the headers. In the illustration, category headers are Show Our Stuff, etc.

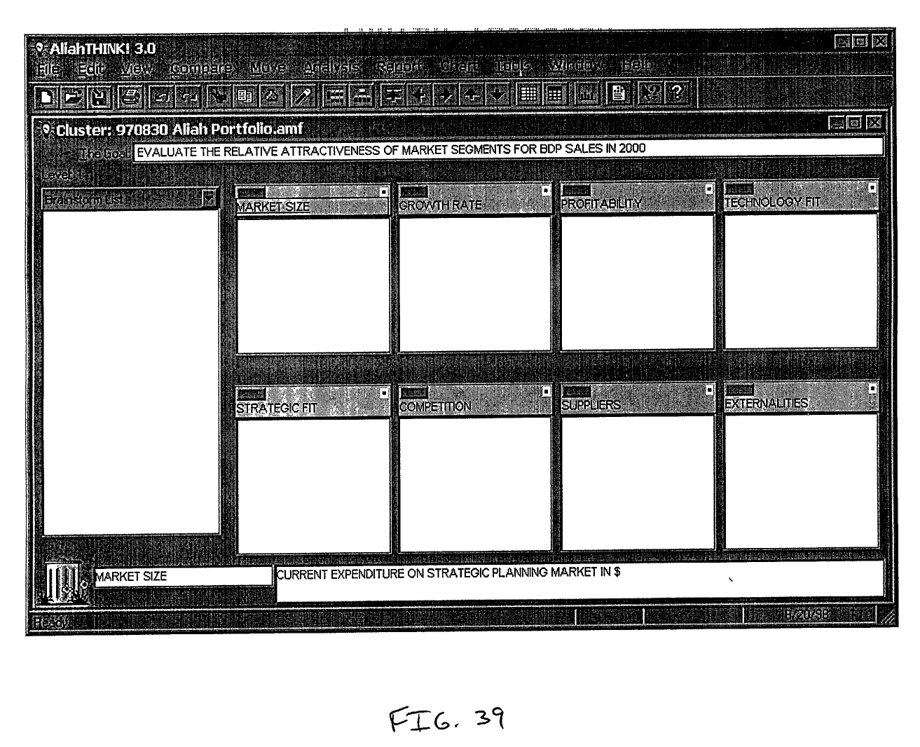

FIG. 38 is a screen printout illustrating the cluster synthesis analysis in hierarchy mode. The hierarchy mode is available to the user by clicking the hierarchy button in the cluster view. As the user drags elements from the synthesis elements list into the buckets under category headers, the category headers accumulate the total of the element weights listed underneath. These weights are the global sum values. If all of the elements in a synthesis elements list were categorized, the global sum values would add to one and would therefore become the weight of the associated category list. Because it is not necessarily desirable to categorize all the synthesis elements, the normalized values are computed as the weights. If all elements of the synthesis elements list are categorized, the normalized values and the global sum values will be equal.

The 5 categories in this FIG. 38 illustration represent new drivers for the user in the planning horizon. They are different than the first set of drivers used in the central player of the user's predict hierarchy (not shown), so the user elected to plug the top four drivers back into the predict hierarchy under the central player. The user then reassessed the likelihood of these new drivers on the future of the central player to determine that an improvement in the future was predicted. The present invention can automatically structure these new drivers with their new weights into the predict hierarchy as an alternative to the original drivers so as to assist the user in the analysis.

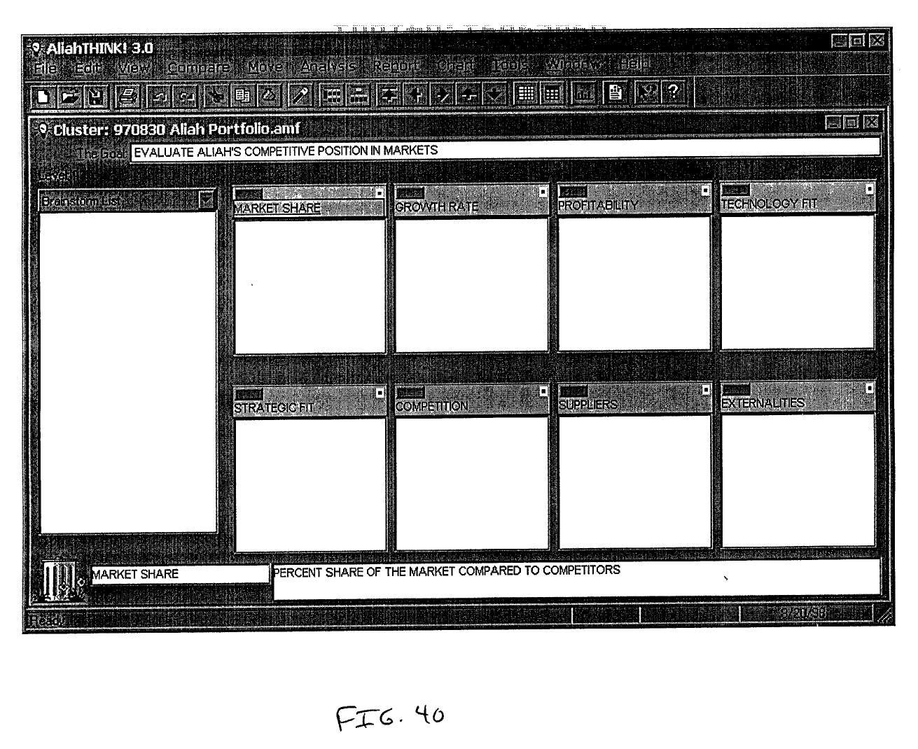

FIG. 39 is a screen printout illustrating a market attractiveness hierarchy for portfolio analysis in the portfolio module 18. There are eight generalized criteria that make a market attractive. Templates may provide brainstorm lists of sub-criteria in order to assist the user in defining the eight criteria for a specific analysis.

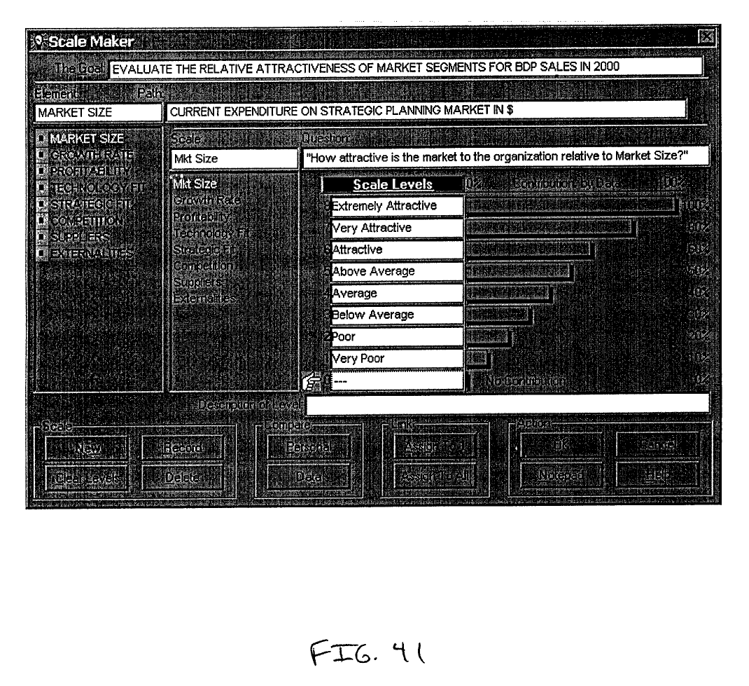

FIG. 40 is a screen printout illustrating a market competitive position hierarchy for portfolio analysis in the portfolio module 18. There are eight generalized criteria that make a user organization competitive in a market and these criteria are defined to mirror the criteria names and definitions used in the attractiveness hierarchy. For example, market size as an attractiveness criterion mirrors an organization size in the competitiveness hierarchy. Templates may provide brainstorm lists of sub-criteria in order to assist the user in defining the eight criteria for a specific analysis.

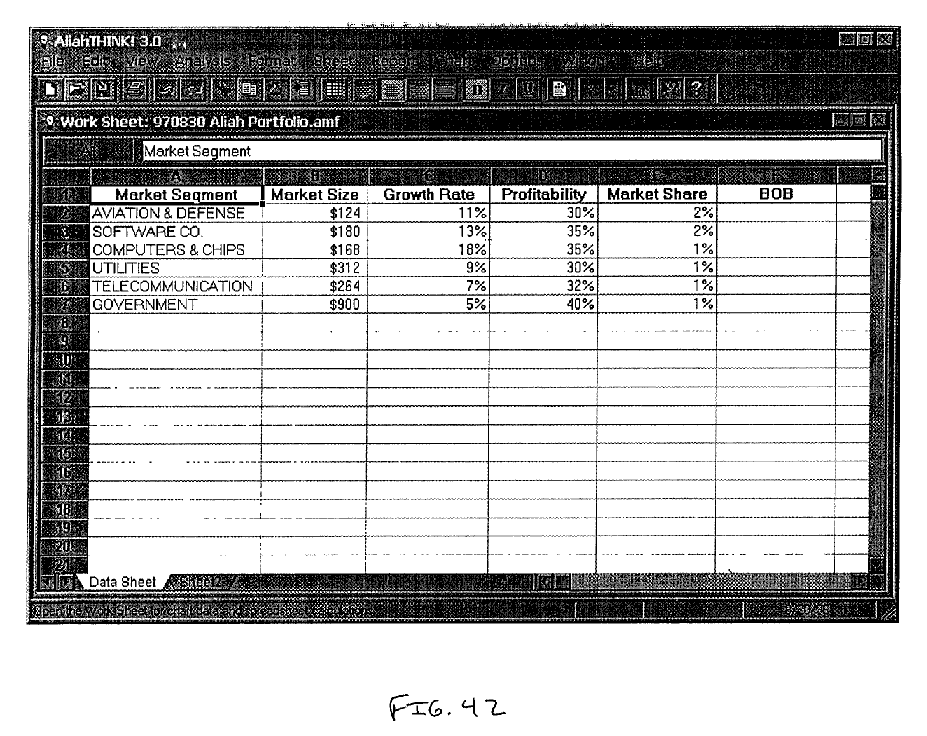

FIG. 41 is a screen printout illustrating the scale maker tool. Scales are needed in order to rate markets as to their attractiveness or as to the competitive position. The scale maker tool assists the user in creating rating scales that are appropriate for specific analysis. The element list is a list of all the enabled leaf elements in the hierarchy. Each of these leaf elements will head a ratings column in the ratings sheet. Markets will be rated as to how attractive they are relative to each leaf element criterion. Therefore, each leaf element criterion must have a rating scale attached to it. The scale maker provides this functionality.

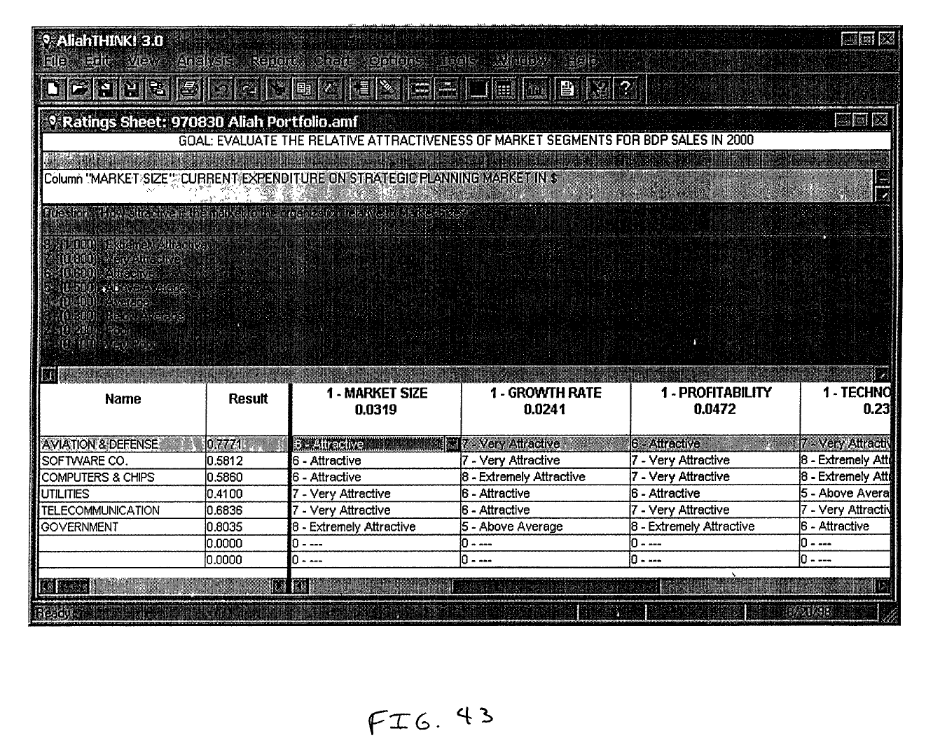

FIG. 42 is a screen printout illustrating a work sheet in a portfolio hierarchy. The work sheet is a workbook of spreadsheets. The spreadsheet contains the financial calculations needed for the user's portfolio analysis. The data in the work sheet contributes to the chart output. The user can enter market names and the associated financial data, both for the market and for the Best Of Breed competition, BOB. The file menu for the work sheet contains menu functions to import and export spreadsheet data in a variety of popular formats, such as, for example. Microsoft Excel and other decision models.

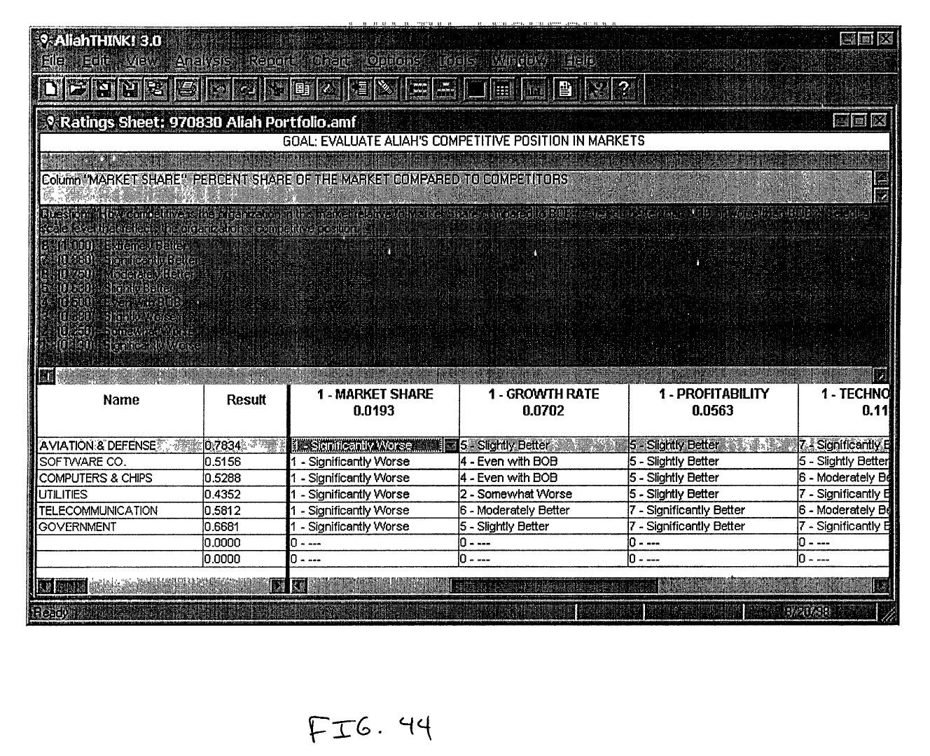

FIG. 43 is a screen printout illustrating a ratings sheet for the attractiveness hierarchy. The user can enter markets into this screen, however if the market names were entered into the work sheet, they will appear in the ratings sheet automatically. As the user tabs from column to column to enter ratings against the criteria, the scale associated with the column criteria element appears on the screen to assist the user. The file menu for the ratings sheet can contain menu functions to import and export spreadsheet data in a variety of popular formats, such as, for example, Microsoft Excel and other decision models.

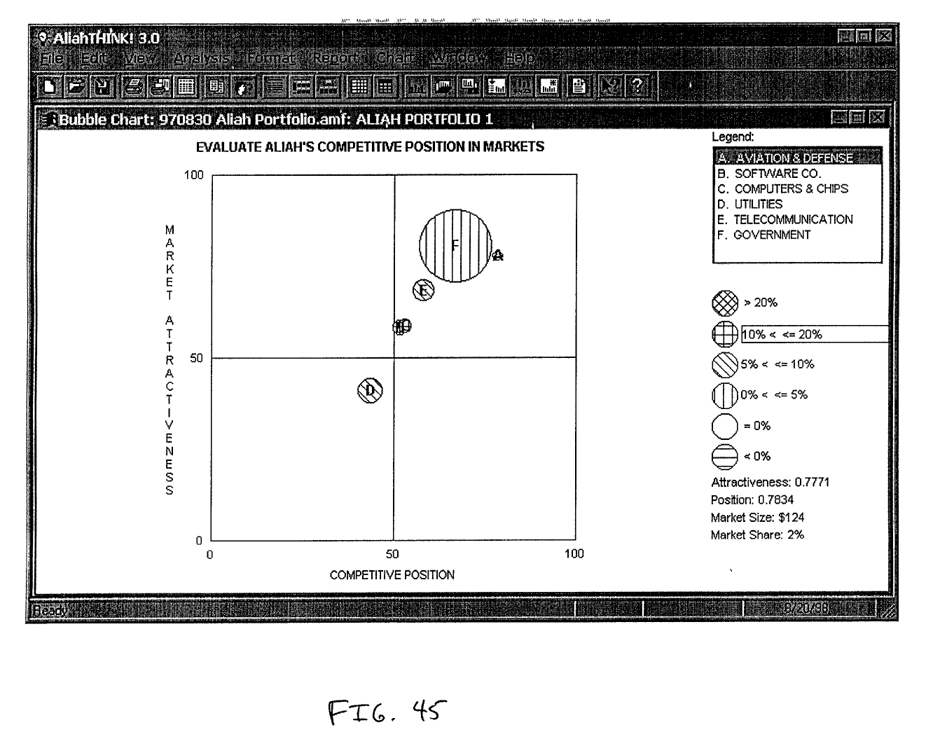

FIG. 44 is a screen printout illustrating a ratings sheet for the competitive position hierarchy. The user can enter markets into this screen, however if the market names were entered into the work sheet, they will appear in this ratings sheet automatically. As the user tabs from column to column to enter ratings against the criteria, the scale associated with the column criteria element appears on the screen to assist the user. In this ratings sheet, the user is rating the user organization against the Best Of Breed competitor, BOB. The selection of a BOB may come, for example, from customer listening exercises using, for example, the listen process of the listen module 16.

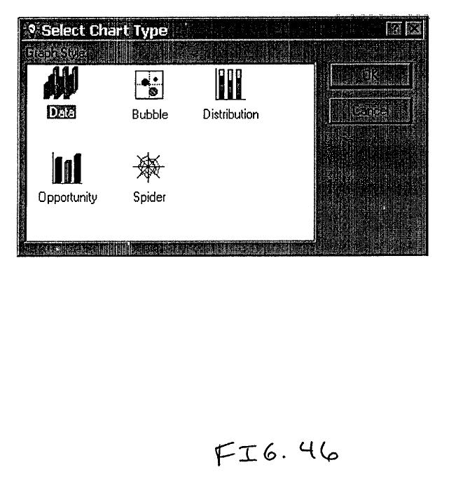

FIG. 45 is a screen printout illustrating a bubble chart that combines data from the work sheet, the attractiveness ratings sheet and the competitiveness ratings sheet.

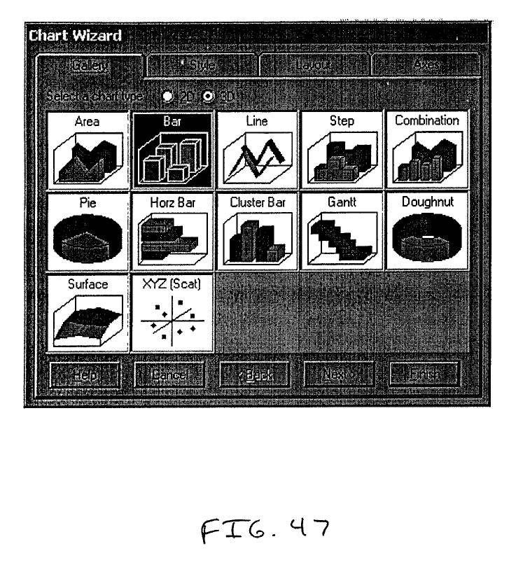

FIG. 46 is a screen printout illustrating examples of other chart types that can combine and display data from various elements of the hierarchy analysis.

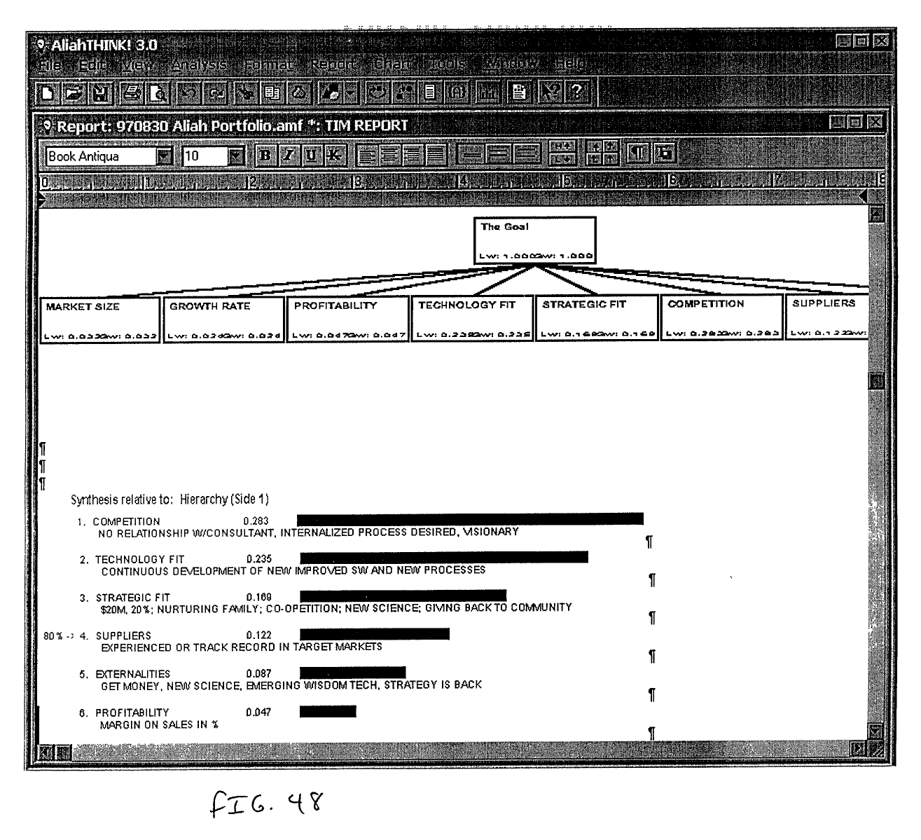

FIG. 47 is a screen printout illustrating the various types of data charts that are available for data charts where data can be obtained, for example, from the work sheet, the attractiveness ratings sheet and the competitiveness ratings sheet.

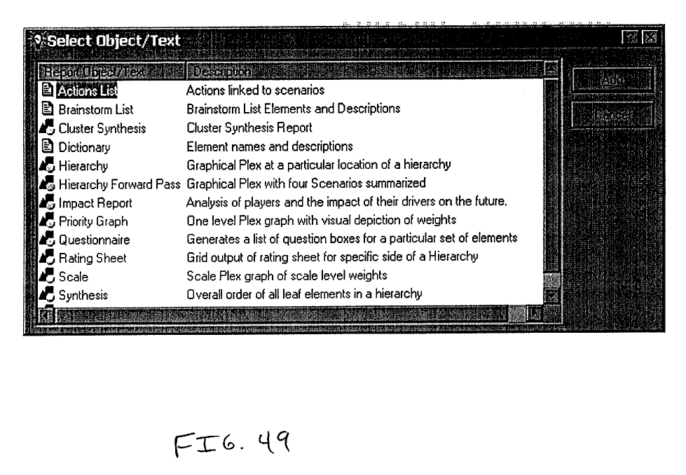

FIG. 48 is a screen printout illustrating the report editor. The report editor provides many features of standard word processors plus it can incorporate the ability to edit and display HTML pages as user reports. Reports and entire hierarchy structures can be imported and exported to the file system for use in other applications such as, for example, use in a word processor, presentation software, e-mail and web browsers.

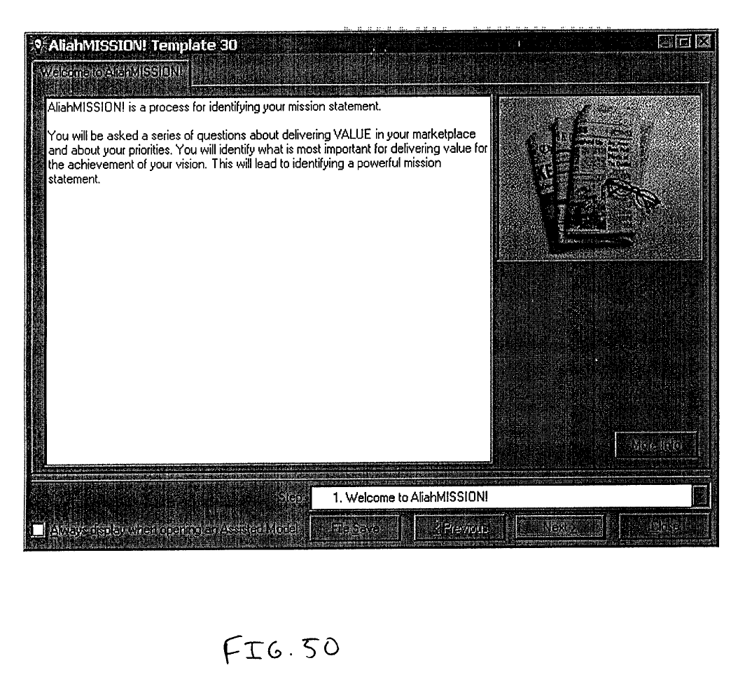

FIG. 49 is a screen printout illustrating the types of updateable report objects that are incorporated into reports. Each report object is linked to hierarchy data and there are menu options to update them to the current hierarchy data either collectively or individually. Report objects also have sets of display options that can be changed by the user.

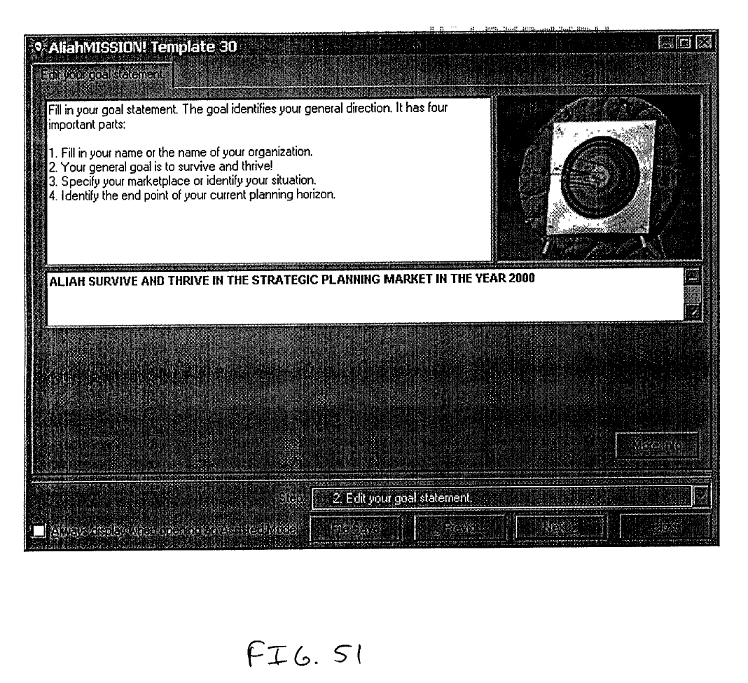

FIGS. 50, 51 and 52 are screen printouts illustrating examples of assistant screens that were configured to assist users in the analysis of a decision-making process. Various step types are provided to guide and assist the user to enter information and to perform evaluations. Assistant step types are available to lead users through each of the screens in the present invention.

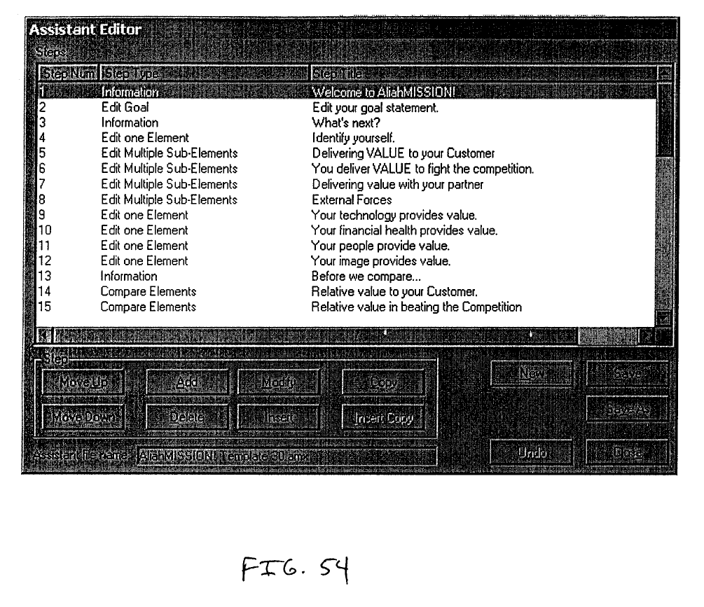

FIG. 53 is a screen printout illustrating the more information screen. The more information screen type is available to be configured to provide optional basic information to assist users who are less familiar with the particular decision-making process.

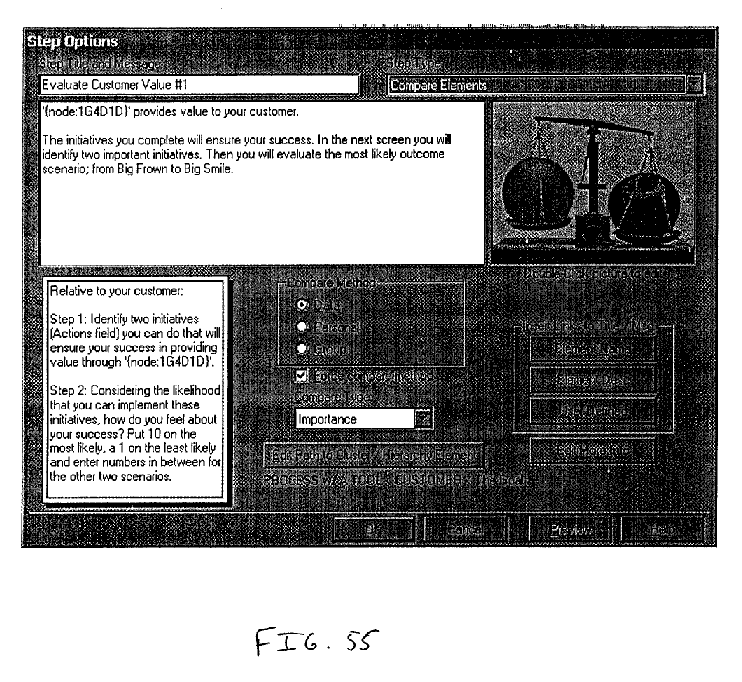

FIG. 54 is a screen printout illustrating the assistant editor tool that allows users to make their own assisted decision processes for distribution, for example in the user's organization. The assistant editor creates an assisted decision model file that can be attached to other decision models, such as, for example, to the predict/plan module 22. The assistant editor provides other facilities such as, for example, the ability to add and delete decision process steps, the ability to copy and to modify existing steps, and the ability to move steps to change step order.

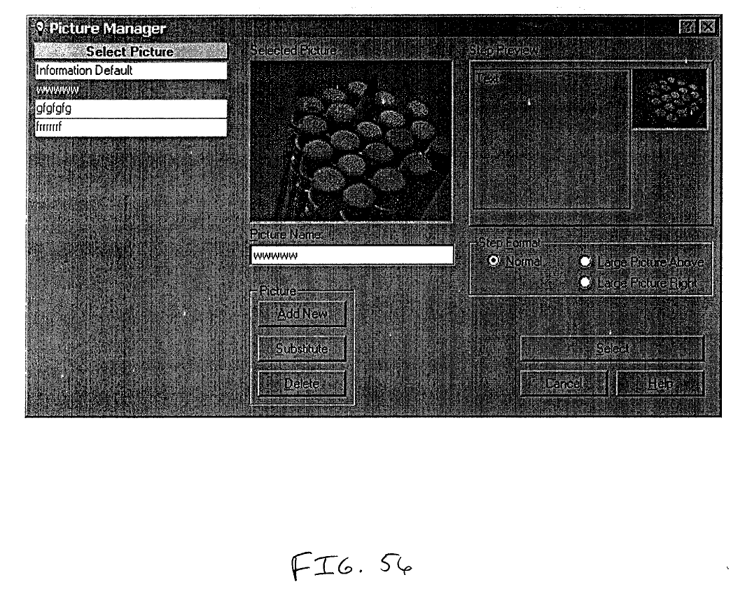

FIG. 55 is a screen printout illustrating the details of configuring an assisted decision process step. The step type is selected from the drop-down in the upper right corner of the screen. The objects on the screen are placed based on the step type selection. Some step types are for information only. Others are for entering data into the goal or hierarchy criteria elements. Still others are to perform comparisons and data analysis. The step illustrated in this screen is for a compare step. A feature of steps is the ability to substitute data that the assisted user will have already entered in a previous step. This is the concept of a data link where the step requests data such as the user's name for later use or the concept of a link to a specific element name or definition in the hierarchy. The link {node:1G4D1D} is a link to a specific element name. This element's name will be substituted on the assisted user's screen when the assisted model is used in assisted mode by the user.

FIG. 56 is a screen printout illustrating how the user can add picture images into the assistant file for use in assistant steps. Picture images can be imported from many computer formats such as, for example, a bitusup or Windows meta file.

While the present invention has been described in conjunction with preferred embodiments thereof, many modifications and variations will be apparent to those of ordinary skill in the art. For example, although the system and method has been described hereinabove as being used in the decision-making or planning process of an organization, the teachings of the present invention may be used in any type of decision-making process. The foregoing description and the following claims are intended to cover all such modifications and variations.

1. A computer-implemented method for planning, comprising:
assessing the viability of an idea based on priorities of those affected by an implementation of said idea;
planning an implementation of said idea; said planning including:
predicting results of said implementation of said idea, based on an assessment of said priorities;
creating a plan based on said predicting; and
automatically re-predicting said results, based on said plan and changes in said priorities as the result of said planning process; and
outputting said plan.

2. The computer-implemented method of claim 1, wherein predicting results include:
building a hierarchy;
evaluating said hierarchy; and
performing an impact analysis.

3. The computer-implemented method of claim 1, wherein creating a plan includes:
building a hierarchy;
prioritizing resources;
synthesizing said hierarchy;
cluster synthesizing actions in said hierarchy; and
performing a pain/gain/risk analysis based on said synthesized actions.

4. The computer-implemented method of claim 1, wherein assessing the viability of an idea includes assessing market attractiveness based on criteria for a desirable market and market segment ratings.

5. The computer-implemented method of claim 1, wherein assessing the viability of an idea includes assessing competitiveness based on competitiveness criteria and competitiveness ratings.

6. The computer-implemented method of claim 1, further comprising the steps of assessing how well an organization is meeting the needs of its customers.

7. The computer-implemented method of claim 6, wherein assessing how well an organization is meeting the needs of its customers includes:
evaluating listen criteria based on customer service requirements; and
developing scales for rating each of said listen criteria to produce a ratings sheet.

8. The computer-implemented method of claim 1, further comprising the step of evaluating judgments of people.

9. The computer-implemented method of claim 8, wherein evaluating judgments of people includes identifying listen criteria based on user-input criteria, criteria importance, and ratings.

10. The computer-implemented method of claim 1, further comprising the step of allocating resources based on said plan.

11. The computer-implemented method of claim 10, wherein allocating resources includes:
prioritizing market segments;
prioritizing strategies;
identifying support for said strategies; and
evaluating alternatives to ensure they meet said strategies.

12. A system, comprising:
a hierarchy engine; and
a predict/plan module in communication with said hierarchy engine, said predict/plan module including:
a plan module; and
a predict module in two-way communication with said plan module.

13. The system of claim 12, further comprising a best-in-class module in communication with said hierarchy engine.

14. The system of claim 12, further comprising a portfolio module in communication with said hierarchy engine.

15. The system of claim 12, further comprising:
a wisdom module in communication with said hierarchy engine;
a wisdom database in communication with said wisdom module; and
a database interface in communication with said wisdom module.

16. The system of claim 15, further comprising an enterprise database in communication with said database interface.

17. The system of claim 12, further comprising an allocate module in communication with said hierarchy engine.

18. The system of claim 12, further comprising a listen module in communication with said hierarchy engine.

19. The system of claim 12, further comprising a network interface in communication with said hierarchy engine.

20. A method for planning, comprising the steps of:
assessing the priorities of marketplace participants;
evaluating alternatives which meet said priorities of said market participants;
planning a course of action based on said evaluation of said alternatives, said planning including:
predicting results based on an implementation of said alternatives;
creating a plan;
re-predicting, based on said plan, results of implementing said plan; and
allocating resources based on said plan;
surveying customers to obtain a better understanding of customer needs;
clarifying business objectives relative to one of said alternatives;
planning a course of action based on clarifying business objectives; and
allocating resources based on said planning.

21. The method of claim 20, wherein evaluating alternatives which meet said needs in said marketplace includes the steps of:
assessing market attractiveness and competitiveness of said alternatives; and
assessing how well an entity is meeting the needs of its customers.

22. An object-oriented planning system for implementation on a computer in an object-oriented framework, comprising:
a hierarchy engine; and
a predict/plan object for generating a plan in conjunction with said hierarchy engine, said predict/plan object including:
a plan object; and
a predict object.

23. The system of claim 22, further comprising a best-in-class object.

24. The system of claim 22, further comprising a portfolio object.

25. The system of claim 22, further comprising a wisdom object.

26. The system of claim 22, further comprising an allocate object.

27. The system of claim 22, further comprising a listen object.

28. A predict/plan module, comprising:
a plan module; and
a predict module in two-way communication with said plan module.

29. A computer-readable medium having stored thereon instructions which, when executed by a processor, cause the processor to perform the steps of:
assessing viability of an idea based on priorities of those affected by an implementation of said idea; and
planning an implementation of said idea, said planning including the steps of:
predicting results of said implementation of said idea based an assessment of said priorities;
creating a plan based on said predicting; and
automatically re-predicting said results, based on said plan and changes in said priorities as the result of said planning process.

30. A system comprising:
a processor; and
a memory, coupled to said processor, and storing a set of ordered data and a set of instructions which, when executed by said processor, cause said processor to perform the steps of:
planning to implement said idea, said planning including:
predicting results based on implementation of said idea;
creating a plan based on said predicting; and
automatically re-predicting, based on said plan, results of implementing said plan; and
outputting said plan.

31. A method for evaluating alternatives ideas in a decision making process, comprising the steps of:
assessing viability of an idea based on priorities of those affected by an implementation of said idea; and
planning an implementation of said idea, said planning including:
predicting results of said implementation of said idea based upon an assessment of said priorities;
creating a plan based on said predicting; and
automatically re-predicting said results, based on said plan and changes in said priorities as the result of said planning process.
